(19) United States
(12) Patent Application Publication
(10) Pub. No.: US 2005/0195227 A1
(43) Pub. Date: Sep. 8, 2005

(54) Liquid ejection apparatus and method of driving the same

(75) Inventors: Ryoichi Tanaka, Suwa-shi (JP); Syuji Yonekubo, Suwa-shi (JP); Gaku Ko, Suwa-shi (JP); Hidetoshi Masuda, Suwa-shi (JP); Tsuyoshi Tomii, Suwa-shi (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION, Shinjuku-ku (JP)

(21) Appl. No.: 10/989,601

(22) Filed: Nov. 17, 2004

(30) Foreign Application Priority Data
Nov. 17, 2003 (JP) 2003-387205
Dec. 10, 2003 (JP) 2003-412202
Dec. 10, 2003 (JP) 2003-412203

(51) Int. Cl. B41J 29/38

(52) U.S. Cl. 347/10

(57) ABSTRACT

A liquid ejection head ejects liquid droplets toward a target medium while being moved in a first direction. A temperature detector detects temperature in a peripheral region of the liquid ejection head. A signal generator generates a first signal including first pulses operable to drive the liquid ejection head so as to eject the liquid droplets toward a unit region in the target medium at a first frequency, and a second signal including second pulses operable to drive the liquid ejection head so as to eject the liquid droplets toward the unit region at a second frequency which is lower than the first frequency. A mode switcher establishes a first mode in which the first pulses are applied to the liquid ejection head when the temperature detector detects that the temperature is no higher than a prescribed temperature, and establishes a second mode in which the second pulses are applied to the liquid ejection head when the temperature detector detects that the temperature is higher than the prescribed temperature. A scan controller moves the liquid ejection head at a first velocity when the first mode is established, and moves the liquid ejection head at a second velocity which is lower than the first velocity when the second mode is established.

### BACKGROUND OF THE INVENTION

This invention relates to a liquid ejection apparatus and a method of driving the same, and particularly to a liquid ejection apparatus in which driving control of a recording head that ejects liquid droplets such as ink droplets from a nozzle can be suitably performed in accordance with the ambient temperature at the time of use, and a method of driving the apparatus.

Conventionally, as a type of liquid ejection apparatus, for example, an ink jet printer that ejects ink droplets from a recording head to print on a print medium has been known. In the printer of this type, the recording head is moved along a primary scanning direction and a print sheet (a kind of print medium) is moved along a secondary scanning direction, and interlocked with these movements, ink droplets are ejected from a nozzle orifice of the recording head to print an image on the print sheet. The ejection of ink droplets is carried out, for example, by deforming a piezoelectric vibrator in accordance with a driving pulse supplied to the recording head and thus expanding or contracting a pressure chamber continued to the nozzle orifice.

A thin box-shaped printer has been recently proposed, assuming that the printer is used as it is housed in a rack or the like together with a so-called AV (audio/visual) device connected with a personal computer (PC). In the printer used as it is housed in the rack or the like together the other AV device as described above, the ambient temperature at the time of use tends to be generally higher than the room temperature because of heat or the like generated by a driving system of the AV device.

Conventionally, in order to address such changes in the ambient temperature, correction such as potential correction or duration correction (hereinafter referred to as “temperature correction”) is performed on each pulse waveform of a head driving signal supplied to the recording head, in accordance with the ambient temperature detected by a sensor or the like, thereby realizing stable ejection of ink droplets (see, for example, Japanese Patent No. 3,356,204). Thus, even when the ambient temperature becomes higher, constant print quality is guaranteed until a certain temperature (for example, 40° C.) is reached.

Meanwhile, in the printer used as it is housed in the rack or the like as described above, the ambient temperature at the time of use may rise to a significantly high temperature, for example, exceeding 40° C., because of the heat filling the rack or the like. If the printer is used in such a high-temperature environment, it may not possible to realize stable ejection of ink droplets simply by the temperature correction as in the conventional technique and therefore it may not be possible to guarantee good print quality. In other words, conventionally, it is not assumed that the printer is used, for example, at an ambient temperature exceeding 40° C. as described above, and no measures have been taken to realize stable ejection of ink droplets in such a high-temperature environment. Therefore, ink droplet ejection stability in the high-temperature environment is lowered, causing a problem that good print quality cannot be maintained.

As a factor that lowers the ink droplet ejection stability, lowering of the viscosity of the ink is considered. The viscosity of the ink is lowered as the ambient temperature rises. As the viscosity of the ink is thus lowered, residual vibration of a meniscus after the ejection of ink droplets increases. This residual vibration prevents ink droplets from being ejected straight and causes deviation of the landing positions of the ink droplets, or it causes the nozzle to take in air bubbles and causes so-called dot omission.

As another factor, recent increase in the frequency of the head driving signal for driving the recording head is considered. That is, by increasing the head driving frequency and thus ejecting ink droplets with high response, improvement in the throughput (higher print velocity) is realized. However, as the ejection interval of ink droplets is reduced by such increase in the frequency, it is more difficult to restrain residual vibration of the meniscus caused by the lowering of the ink viscosity when it occurs as described above.

### SUMMARY OF THE INVENTION

It is therefore an object of the invention to provide a liquid ejection apparatus and a method of driving the same, which are capable of stably ejecting liquid droplets even when the apparatus is used under a high-temperature emvironment.

In order to achieve the above object, according to the invention, there is provided a liquid ejection apparatus, comprising:

a liquid ejection head, which ejects liquid droplets toward a target medium while being moved in a first direction;

a temperature detector, which detects temperature in a peripheral region of the liquid ejection head;

a signal generator, which generates a first signal including first pulses operable to drive the liquid ejection head so as to eject the liquid droplets toward a unit region in the target medium at a first frequency, and a second signal including second pulses operable to drive the liquid ejection head so as to eject the liquid droplets toward the unit region at a second frequency which is lower than the first frequency;

a mode switcher, which establishes a first mode in which the first pulses are applied to the liquid ejection head when the temperature detector detects that the temperature is no higher than a prescribed temperature, and establishes a second mode in which the second pulses are applied to the liquid ejection head when the temperature detector detects that the temperature is higher than the prescribed temperature; and

a scan controller, which moves the liquid ejection head at a first velocity when the first mode is established, and moves the liquid ejection head at a second velocity which is lower than the first velocity when the second mode is established.

With this configuration, when the temperature of the environment where the liquid ejection apparatus is used exceeds the prescribed value, the liquid ejection head can be driven by the signal having the relatively lower frequency than the frequency in normal driving, so that the ejection interval of liquid droplets ejected from the liquid ejection head can be made longer. Consequently, even in the high-temperature environment where the viscosity of liquid is lowered, residual vibration due to the meniscus and the like can be properly restrained, so that ink droplets can be ejected stably. In other words, it is possible to set the ambient temperature that can be guaranteed at the time of using the liquid ejection apparatus, to a higher value.

Preferably, each of the first pulses has an identical waveform with each of the second pulses.

With this configuration, as the pulse spacing of the driving signal generated when the temperature is high is made longer than when the temperature is normal, the ejection interval of ink droplets can be made longer in the high-temperature environment where the viscosity of ink is lowered, and ink droplets can be ejected stably.

Preferably, a ratio of the first frequency to the second frequency is identical with a ratio of the first velocity to the second velocity.

With this configuration, the number of ink droplets ejected per unit region in one scanning operation by the liquid ejection head can be made equal in the first mode and the second mode. Therefore, whichever mode is used for driving the liquid ejection head, similar print image quality can be realized.

In this case, the time period required to finish a prescribed job under the second mode becomes longer (for example, twice) than that under the first mode. Under the high-temperature environment in which the viscosity of liquid lowers, the required operation time period and the stability of the liquid ejection revolt against each other. Here, the stablity of the liquid ejection is enhanced at the sacrifice of the required operation time period (making the ejection interval of the liquid droplets longer), thereby securing the enhanced landing quality of liquid droplets even under the high-temperature environment. Thus, it is possible to set the ambient temperature that can be guaranteed at the time of using the liquid ejection apparatus, to a higher value.

Preferably, the mode switcher establishes either the first mode or the second mode at the beginning of a unit ejection job, and the established mode is held during the unit ejection job.

If the moving velocity of the liquid ejection head is changed during the execution of one unit liquid ejection job, it is anxious that the landing quality of liquid droplets (for example, color difference in the case of printing) differs in accordance with the change of the moving velocity. Such a situation can be avoided by the above configuration.

Preferably, the liquid ejection apparatus further comprises a pulse corrector, which corrects a waveform of each of the first pulses and the second pulses in accordance with the temperature detected by the temperature detector.

With this configuration, in addition to executing the switching control of each mode in accordance with the ambient temperature, temperature correction according to the ambient temperature is performed on each waveform of the signal generated in each mode. As a result, the ejection stability of liquid droplets can be further improved.

Preferably, the liquid ejection head also ejects the liquid droplets while being moved in a second direction opposite to the first direction. An ejection timing of each of the liquid droplets is adjusted in accordance with the direction that the liquid ejection head moves and the mode established by the mode switcher.

With this configuration, deviation from the prescribed liquid ejecting position in connection with the bi-directional scanning is adjusted with a value generated in each mode. Accordingly, the deterioration of the landing quality of liquid droplets due to the mode switching can be suppressed.

Here, it is preferable that the ejection timing is adjusted also in accordance with a distance between the liquid ejection head and the target medium.

With this configuration, the deviation adjustement in connection with the bi-directional scanning can be performed more accurately. For example, the above distance is selected in accordance with the kind of the target medium.

According to the invention, there is also provided a method of driving a liquid ejection apparatus which comprises a liquid ejection head operable to eject liquid droplets toward a target medium while being moved in a first direction, the method comprising steps of:

detecting temperature in a peripheral region of the liquid ejection head;

generating at least one of a first signal including first pulses operable to drive the liquid ejection head so as to eject the liquid droplets toward a unit region in the target medium at a first frequency, and a second signal including second pulses operable to drive the liquid ejection head so as to eject the liquid droplets toward the unit region at a second frequency which is lower than the first frequency;

establishing a first mode in which the first pulses are applied to the liquid ejection head when the detected temperature is no higher than a prescribed temperature;

establishing a second mode in which the second pulses are applied to the liquid ejection head when the detected temperature is higher than the prescribed temperature;

moving the liquid ejection head at a first velocity when the first mode is established; and

moving the liquid ejection head at a second velocity which is lower than the first velocity when the second mode is established.

Preferably, either the first mode or the second mode at the beginning of a unit ejection job, and the established mode is held during the unit ejection job.

Preferably, the driving method further comprises a step of correcting a waveform of each of the first pulses and the second pulses in accordance with the detected temperature.

According to the invention, there is also provided a liquid ejection apparatus, comprising:

a liquid ejection head, which ejects liquid droplets toward a target medium while being moved in a first direction, the target medium having a plurality of unit regions arrayed in the first direction to form a target row;

a temperature detector, which detects temperature in a peripheral region of the liquid ejection head;

a signal generator, which generates a first signal including first pulses operable to drive the liquid ejection head so as to eject the liquid droplets toward every one of the unit regions, and a second signal including second pulses operable to drive the liquid ejection head so as to eject the liquid droplets toward every N-th one of the unit regions;

a mode switcher, which establishes a first mode in which the first pulses are applied to the liquid ejection head when the temperature detector detects that the temperature is no higher than a prescribed temperature, and establishes a second mode in which the second pulses are applied to the liquid ejection head when the temperature detector detects that the temperature is higher than the prescribed temperature; and

a scan controller, which moves the liquid ejection head once to complete the liquid droplet ejection with respect to the target row when the first mode is established, and moves the liquid ejection head N-times to complete the liquid droplet ejection with respect to the target row when the second mode is established.

With this configuration, even in the high-temperature environment where the viscosity of liquid is lowered, the residual vibration of the meniscus superimposed by the continuous ejection of liquid droplets can be properly damped by utilizing the period in which the ejection operation is not performed. Consequently, it is possible to stably eject liquid droplets and it is possible to set the ambient temperature that can be guaranteed at the time of using the liquid ejection apparatus, to a higher value.

As to the operation type of the liquid ejection head, it may be a type in which liquid droplets are ejected when the liquid ejection head is moved forward (single directional operation), or may be a type in which liquid droplets are ejected both of when the liquid ejection head is moved forward and when the liquid ejection head is moved backward (bi-directional operation).

Preferably, the N is 2.

With this configuration, as to a single scanning of the liquid ejection head, after the liquid ejection is performed with respect to one unit region, it is not executed the liquid ejection with respect to a subsequent unit region. Accordingly, the residual vibration of the meniscus can be properly damped by utilizing the time period in which the liquid ejection is not performed.

Preferably, a frequency of the first signal is identical with a frequency of the second signal; and a velocity of the liquid ejection head in the first mode is identical with a velocity of the liquid ejection head in the second mode.

With this configuration, it is possible to suppress the generation of the landing quality difference of liquid droplets due to the change of the liquid ejection timing.

Preferably, the mode switcher establishes either the first mode or the second mode at the beginning of a unit ejection job, and the established mode is held during the unit ejection job.

With this configuration, it is possible to suppress the generation of the landing quality difference of liquid droplets during the exection of one unit liquid ejection job.

Preferably, the liquid ejection apparatus further comprises a pulse corrector, which corrects a waveform of each of the first pulses and the second pulses in accordance with the temperature detected by the temperature detector.

With this configuration, in addition to executing the switching control of each mode in accordance with the ambient temperature, temperature correction according to the ambient temperature is performed on each waveform of the signal generated in each mode. As a result, the ejection stability of liquid droplets can be further improved.

According to the invention, there is also provided a method of driving a liquid ejection apparatus which comprises a liquid ejection head operable to eject liquid droplets toward a target medium having a plurality of unit regions arrayed in a first direction to form a target row, while being moved in the first direction, the method comprising steps of:

detecting temperature in a peripheral region of the liquid ejection head;

generating at least one of a first signal including first pulses operable to drive the liquid ejection head so as to eject the liquid droplets toward every one of the unit regions, and a second signal including second pulses operable to drive the liquid ejection head so as to eject the liquid droplets toward every N-th one of the unit regions;

establishing a first mode in which the first pulses are applied to the liquid ejection head when the detected temperature is no higher than a prescribed temperature;

establishing a second mode in which the second pulses are applied to the liquid ejection head when the detected temperature is higher than the prescribed temperature;

moving the liquid ejection head once to complete the liquid droplet ejection with respect to the target row when the first mode is established; and

moving the liquid ejection head N-times to complete the liquid droplet ejection with respect to the target row when the second mode is established.

Preferably, a frequency of the first signal is identical with a frequency of the second signal. A velocity of the liquid ejection head in the first mode is identical with a velocity of the liquid ejection head in the second mode.

Preferably, either the first mode or the second mode at the beginning of a unit ejection job, and the established mode is held during the unit ejection job.

Preferably, the driving method further comprises a step of correcting a waveform of each of the first pulses and the second pulses in accordance with the detected temperature.

According to the invention, there is also provided a liquid ejection apparatus, comprising:

a liquid ejection head, which ejects liquid droplets toward a target medium while being moved in a first direction, the target medium having a plurality of unit regions arrayed in the first direction to form a target row;

a temperature detector, which detects temperature in a peripheral region of the liquid ejection head;

a signal generator, which generates a first signal including first pulses operable to drive the liquid ejection head so as to eject the liquid droplets toward every one of the unit regions at a first frequency, and a second signal including second pulses operable to drive the liquid ejection head so as to eject the liquid droplets toward every one of the unit regions at a second frequency which is one N-th of the first frequency;

a mode switcher, which establishes a first mode in which the first pulses are applied to the liquid ejection head when the temperature detector detects that the temperature is no higher than a prescribed temperature, and establishes a second mode in which the second pulses are applied to the liquid ejection head when the temperature detector detects that the temperature is higher than the prescribed temperature; and

a scan controller, which moves the liquid ejection head once to complete the liquid droplet ejection with respect to the target row when the first mode is established, and moves the liquid ejection head N-times to complete the liquid droplet ejection with respect to the target row when the second mode is established.

With this configuration, when the environment where the liquid ejection apparatus is used is high-temperature environment exceeding the prescribed temperature, the liquid ejection head is driven by the signal having the relatively lower frequency than in the normal-temperature environment. Thus, the ejection interval of liquid droplets ejected from the liquid ejection head can be made longer and enough time to enable damping of the residual vibration of the meniscus can be secured. Therefore, the residual vibration of the meniscus can be properly restrained even in the high-temperature environment and the liquid droplet ejection stability can be improved. In other words, it is possible to set the ambient temperature that can be guaranteed at the time of using the liquid ejection apparatus, to a higher value.

Preferably, the N is 2 and a velocity of the liquid ejection head in the first mode is identical with a velocity of the liquid ejection head in the second mode.

In this case, some of the unit regions which have not been subjected to the liquid ejection under the first scanning can be supplementally subjected to the liquid ejection under the second scanning. As to the operation type of the liquid ejection head, it may be a type in which liquid droplets are ejected when the liquid ejection head is moved forward (single directional operation), or may be a type in which liquid droplets are ejected both of when the liquid ejection head is moved forward and when the liquid ejection head is moved backward (bi-directional operation).

Preferably, the mode switcher establishes either the first mode or the second mode at the beginning of a unit ejection job, and the established mode is held during the unit ejection job.

With this configuration, it is possible to suppress the generation of the landing quality difference of liquid droplets due to the change of the liquid ejection timing.

Preferably, the liquid ejection apparatus further comprises a pulse corrector, which corrects a waveform of each of the first pulses and the second pulses in accordance with the temperature detected by the temperature detector.

According to the invention, there is also provided a method of driving a liquid ejection apparatus which comprises a liquid ejection head operable to eject liquid droplets toward a target medium having a plurality of unit regions arrayed in a first direction to form a target row, while being moved in the first direction, the method comprising steps of:

detecting temperature in a peripheral region of the liquid ejection head;

generating at least one of a first signal including first pulses operable to drive the liquid ejection head so as to eject the liquid droplets toward every one of the unit regions at a first frequency, and a second signal including second pulses operable to drive the liquid ejection head so as to eject the liquid droplets toward every one of the unit regions at a second frequency which is one N-th of the first frequency;

establishing a first mode in which the first pulses are applied to the liquid ejection head when the detected temperature is no higher than a prescribed temperature;

establishing a second mode in which the second pulses are applied to the liquid ejection head when the detected temperature is higher than the prescribed temperature;

moving the liquid ejection head once to complete the liquid droplet ejection with respect to the target row when the first mode is established; and

moving the liquid ejection head N-times to complete the liquid droplet ejection with respect to the target row when the second mode is established.

Preferably, a velocity of the liquid ejection head in the first mode is identical with a velocity of the liquid ejection head in the second mode.

Preferably, either the first mode or the second mode at the beginning of a unit ejection job, and the established mode is held during the unit ejection job.

Preferably, the driving method further comprises a step of correcting a waveform of each of the first pulses and the second pulses in accordance with the detected temperature.

### BRIEF DESCRIPTION OF THE DRAWINGS

FIG. 1 is a schematic perspective view of a printer (liquid ejection apparatus) according to a first embodiment of the invention;

FIG. 2 is a schematic perspective view of an internal appearance of the printer showing a state where an outer housing of FIG. 1 is removed;

FIG. 3 is a schematic section view showing one exemplary configuration of a recording head in the printer of FIG. 1;

FIG. 4 is a block diagram showing an electrical configuration of the printer of FIG. 1;

FIG. 5A is an explanatory diagram showing a normal driving signal corresponding to a first operation mode of the printer of FIG. 1;

FIG. 5B is an explanatory diagram showing a high-temperature driving signal corresponding to a second operation mode of the printer of FIG. 1;

FIG. 6 is a flow chart showing a control routine in connection with a head driving control of the printer of FIG. 1;

FIG. 7 is an explanatory diagram showing one example of a print result which is obtained by the control routine of FIG. 6;

FIG. 8 is an explanatory diagram showing a modified example of the head driving control of the printer of FIG. 1;

FIG. 9 is an explanatory diagram showing a head driving control of a printer according to a second embodiment of the printer;

FIG. 10A is an explanatory diagram showing a normal driving signal corresponding to a first operation mode of the printer of FIG. 9;

FIG. 10B is an explanatory diagram showing a high-temperature driving signal corresponding to a second operation mode of the printer of FIG. 9;

FIG. 11 is an explanatory diagram showing a modified example of the head driving control of the printer of FIG. 9;

FIG. 12 is an explanatory diagram showing a head driving control of a printer according to a third embodiment of the printer;

FIG. 13A is an explanatory diagram showing a normal driving signal corresponding to a first operation mode of the printer of FIG. 12;

FIG. 13B is an explanatory diagram showing a high-temperature driving signal corresponding to a second operation mode of the printer of FIG. 12; and

FIG. 14 is an explanatory diagram showing a modified example of the head driving control of the printer of FIG. 12;

### DETAILED DESCRIPTION OF THE INVENTION

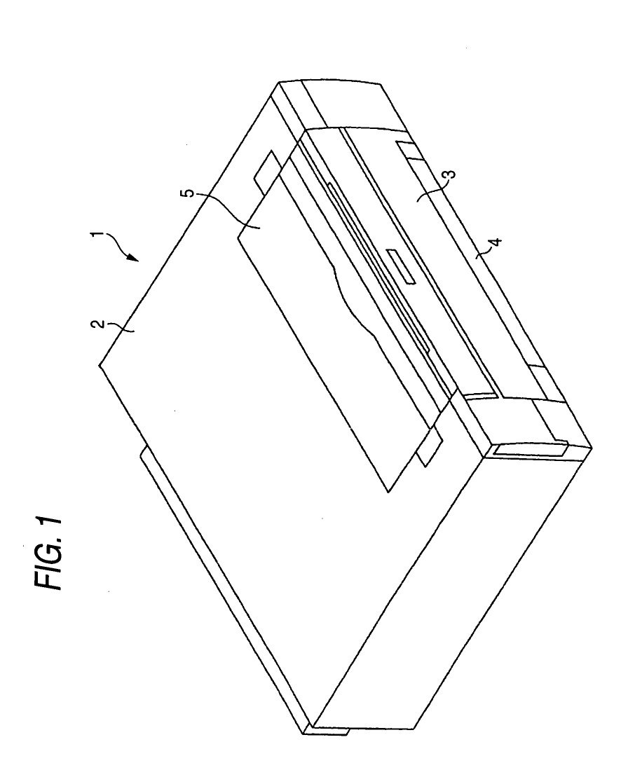

Hereinafter, an ink jet printer (liquid ejection apparatus) according to a first embodiment of this invention will be described with reference to FIGS. 1 through 7.

As shown in FIG. 1, this printer 1 has a substantially box-like shape and it is formed approximately in the size of a video tape recorder, for example, on the assumption that the printer is used as it is housed in a television rack or the like.

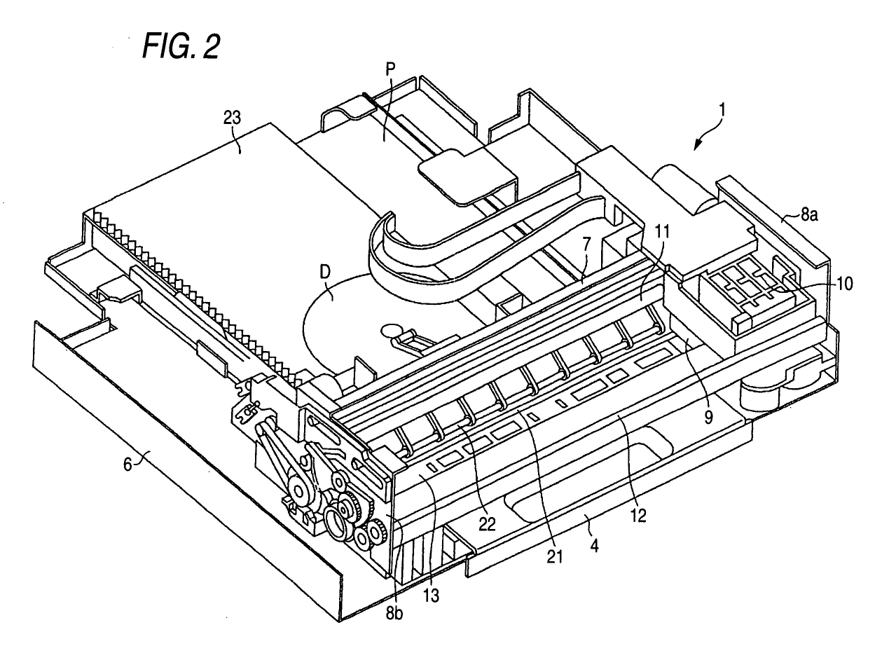

The schematic structure of this printer 1 will now be described. A front cover 3 is provided on the front side of an outer housing 2 having a substantially box-like shape. This front cover 3 is constructed to pivot freely between a state of being open forward (used state) and a state of being closed (non-used state). A feeder tray 4 is provided movably below this front cover 3, and as this feeder tray 4 is pulled forward and taken out, a print sheet P as a print medium (see FIG. 2) can be set thereon. An ink cartridge unit 5 is provided above the front cover 3. In this ink cartridge unit 5, plural ink cartridges, not shown, are arrayed in the direction of width and removably provided.

Next, the inner structure of this printer 1 will be described with reference to FIG. 2.

In the printer 1, there are provided a lower chassis 6, a main frame 7 extending in a primary scanning direction, which is the direction of the width of the printer 1, and a pair of side frames 8a, 8b provided upright on both sides of the main frame 7 and parallel to a secondary scanning direction, which is the direction of the depth of the printer 1. Between this pair of side frames 8a, 8b, a main guide shaft 11 and a sub guide shaft 12 for guiding a carriage 10 to which a recording head 9 having multiple nozzles for individual colors (not shown) is attached, in the primary scanning direction, are provided at a predetermined spacing in the secondary scanning direction. As the main guide shaft 11 is inserted in a rear part of the carriage 10 and the sub guide shaft 12 supports a front part of the carriage 10 from below, a clearance (so-called platen gap) between the recording head 9 and a platen 13, which is a guide member arranged to face the recording head 9, is defined.

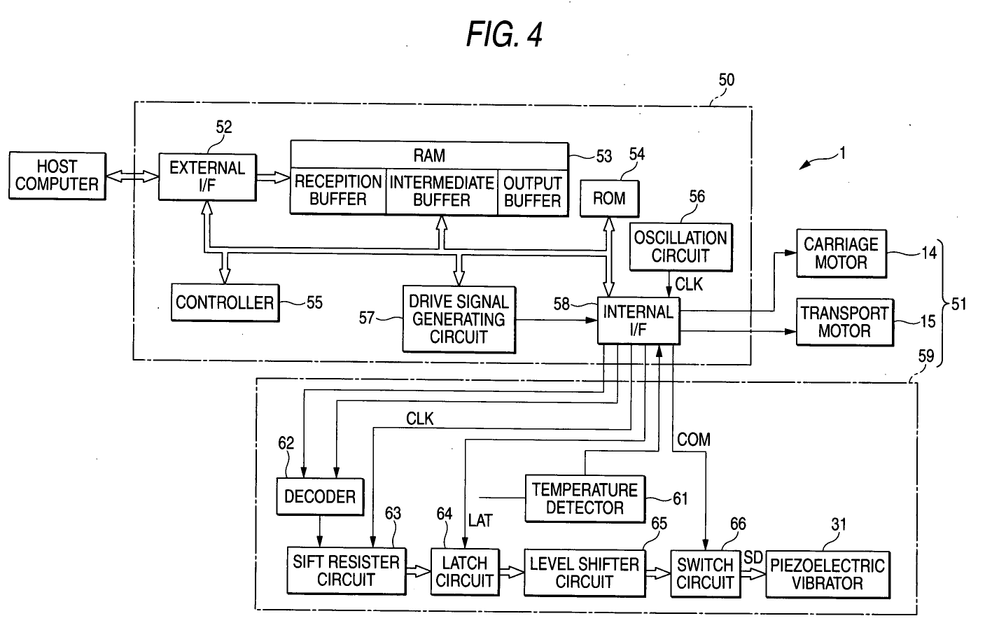

By a rotational driving force of a carriage motor 14 (see FIG. 4), the carriage 10 is reciprocated by this force along the guide shafts 11 and 12 in the primary scanning direction. In other words, as this carriage motor 14 is rotation-controlled, the recording head 9 can be reciprocated together with the carriage 10 in the primary scanning direction.

The print sheet P set on the feeder tray 4 is guided onto the platen 13 and carried to a position below the recording head 9 by a transport driving roller 21 rotationally driven by a transport motor 15 (see FIG. 4) and a transport following motor 22 rotated following the rotation of the transport driving roller 21. Then, as ink droplets are ejected (jetted) from the recording head 9 onto the carried print sheet P while the print sheet P is supported by the platen 13 from below, printing is carried out.

Although the recording head 9 is provided below the carriage 10, this carriage 10 is not equipped with any ink cartridge, and plural ink cartridges are removably arrayed in the primary scanning direction above a primary scanning region of the carriage 10, as described above. Ink is supplied to the carriage via an ink tube, not shown.

Downstream from the recording head 9, an ejection driving roller rotationally driven by the transport motor and an ejection following roller rotated following the rotation of the ejection driving roller are provided, though not shown. By these rollers, the print sheet P is ejected out of the printer 1.

Also, in this printer 1, a disc tray 23 is provided on which an optical disc D such as DVD (digital versatile disk) can be set. This disc tray 23 is arranged above the feeder tray 4. As the disc tray 23 with the optical disc D set thereon is carried to a position below the recording head 9, ink droplets can be directly ejected onto a label surface of the optical disc D to carry out printing.

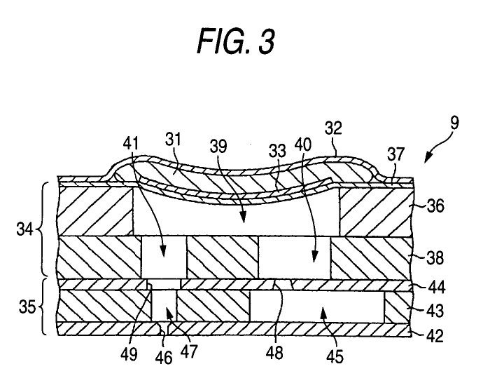

As shown in FIG. 3, the recording head 9 has a piezoelectric vibrator 31 as an actuator, an upper electrode 32 provided on a top surface of the piezoelectric vibrator 31, a lower electrode 33 provided on a bottom surface of the piezoelectric vibrator 31, a pressure generating unit 34, and a flow path unit 35.

The pressure generating unit 34 includes a pressure chamber formation substrate 36, and a diaphragm 37 and a flow path formation substrate 38 that are joined on both sides of the pressure chamber formation substrate 36. In the pressure chamber formation substrate 36, a pressure chamber 39 is formed at a position corresponding to the piezoelectric vibrator 31.

The diaphragm 37 is joined to a top surface of the pressure chamber formation substrate 36, and the piezoelectric vibrator 31 is stacked on the lower electrode 33 provided on a top surface of this diaphragm 37. The flow path formation substrate 38 is joined to a bottom surface of the pressure chamber formation substrate 36. In this flow path formation substrate 38, a first ink flow path 40 and a second ink flow path 42 that continue to the pressure chamber 39 are formed.

The flow path unit 35 includes a nozzle plate 42, a reservoir formation substrate 43, and a supply port formation substrate 44. The nozzle plate 42 and the supply port formation substrate 44 are joined to a bottom surface and a top surface of the reservoir formation substrate 43, respectively, so as to sandwich the reservoir formation substrate 43. This flow path unit 35 is joined to a bottom surface of the pressure generating unit 34.

In the reservoir formation substrate 43, an ink reservoir 45 for storing ink, and a first nozzle continuing hole 47 continuing to the nozzle 46 formed in the nozzle plate 42, are formed. In the supply port formation substrate 44, an ink supply port 48 continuing to the ink reservoir 45 and the first ink flow path 40 and adapted for supplying the ink stored in the ink reservoir 45 to the pressure chamber 39, and a second nozzle continuing hole 49 continuing to the first nozzle continuing hole 47 and the second ink flow path 41, are formed.

In the recording head 9 constructed as described above, a series of ink flow paths is formed from the ink reservoir 45 through the pressure chamber 39 to the nozzle 46. In this recording head 9, the boards 36, 38 and 43 are produced, for example, by etching silicon wafers. However, the recording head is not limited to this structure, and the ink flow paths may be formed, for example, by forming the pressure chamber 39, the ink flow paths 40, 41, the ink reservoir 45 and the like in metal plates or the like and then stacking and adhering these metal plates with each other.

In the recording head 9 of such a structure, when the piezoelectric vibrator 31 is deformed (contracted) by charging, the diaphragm 37 flexes the pressure chamber 39 contracts. On the other hand, when the piezoelectric vibrator 31 is deformed (expanded) by discharging from this contracted state of the pressure chamber 39, the pressure chamber 39 is expanded by the elasticity of the diaphragm 37. As the pressure chamber 39 is temporarily expanded and then contracted by such deformations of the piezoelectric vibrator 31 due to charging and discharging, the ink pressure within the pressure chamber 39 is increased and ink droplets are ejected from the nozzle 46.

As shown in FIG. 4, the printer 1 has a printer controller 50 and a print engine 51. The printer controller 50 has an external interface (external I/F) 52, a RAM 53 for temporarily storing various data, a ROM 54 storing a control program and the like, a controller 55 including a CPU and the like, an oscillation circuit 56 for generating a clock signal CLK, a driving signal generating circuit 57 for generating a common driving signal COM to be supplied to the recording head 9, and an internal interface (internal I/F) 58. On the other hand, the print engine 51 includes the carriage motor 14, the transport motor 15, and an electric driving system 59 of the recording head 9.

First, the printer controller 50 will be described. The external I/F 52 receives print data including, for example, character codes, graphic functions, image data and the like from a host computer (for example, personal computer), or transmits a busy signal (BUSY), an acknowledge signal (ACK) and the like outputted from the controller 55 to the host computer.

The internal I/F 58 transmits the common driving signal COM generated by the driving signal generating circuit 57, dot pattern data (also referred to as bit map data) generated by the controller 55 and the like to the electric driving system 59 of the recording head 9, or acquires the temperature in a peripheral region of the recording head 9 detected as the ambient temperature at the time of use of the printer 61 by a temperature detector 61, which will be described later.

The RAM 53 has a receiving buffer, an intermediate buffer, an output buffer, and a work memory (not shown). The receiving buffer temporarily stores the print data received via the external I/F 52. The intermediate buffer stores intermediate code data converted by the controller 55. The output buffer stores the dot pattern data. The dot pattern data is print data acquired by decoding (translating) the intermediate code data (for example, gradation data).

In the ROM 54, a control program (control routine) for performing various data processing as well as font data, graphic functions and the like are stored. Moreover, in this ROM 54, a table for correcting the potential and duration of the driving signal in the common driving signal COM supplied to each piezoelectric vibrator 31 of the recording head in accordance with the ambient temperature at the time of use of the printer 1 (hereinafter referred to as “temperature correction”), and control data for switching operation modes, which will be described later, are stored. In this embodiment, the ROM 54 and the controller 55 serve a corrector which performs the temperature correction.

The controller 55 performs various controls in accordance with the control program stored in the ROM. For example, the controller 55 reads out print data in the receiving buffer, converts this print data to intermediate code data, and stores the intermediate code data into the intermediate buffer. The controller 55 also analyzes intermediate code data read out from the intermediate buffer and converts (decodes) the intermediate code data to dot pattern data with reference to the font data, graphic functions and the like stored in the ROM 54. Then, the controller 55 performs necessary decoration processing and then stores this dot pattern data into the output buffer.

If dot pattern data for one line that can be recorded (printed) by one primary scanning operation with the recording head 9 is acquired, the controller 55 reads out this dot pattern data for one line from the output buffer and sequentially outputs the dot pattern data to the electric driving system 59 of the recording head 9 through the internal I/F 58. Thus, the carriage 10 is caused to scan and printing of one line is performed. When the dot pattern data for one line is outputted from the output buffer, the converted intermediate code data is deleted from the intermediate buffer and conversion processing of the next intermediate code data is performed.

The electric driving system 59 has a temperature detector 61 as a temperature detecting unit, a decoder 62, a shift register circuit 63, a latch circuit 64, a level shifter circuit 65, a switch circuit 66, and the piezoelectric vibrator 31. Each of the decoder 62, the shift register circuit 63, the latch circuit 64, the level shifter circuit 65, the switch circuit 66 and the piezoelectric vibrator 31 is provided for each nozzle 37 of the recording head 9.

In this electric driving system 59, if pulse selection data from the level shifter circuit 65 that is applied to the switch circuit 66 is “1”, the switch circuit 66 is set in a connection state and a pulse waveform in the common driving signal COM is directly applied to the piezoelectric vibrator 31. The piezoelectric vibrator 31 is deformed in accordance with the pulse waveform. On the other hand, if pulse selection data from the level shifter circuit 65 that is applied to the switch circuit 66 is “0”, the switch circuit 66 is set in a non-connection state and the supply of the common driving signal COM to the piezoelectric vibrator 31 is shut down. In this manner, the switch circuit 66 generates a driving signal (head driving signal SD) to be supplied to each piezoelectric vibrator 31 of the recording head 9 on the basis of the common driving signal COM and the pulse selection data from the level shifter circuit 65.

In this embodiment, in order to generate such a driving signal (head driving signal SD) at a frequency depending on the temperature in the peripheral region of the recording head 9 detected by the temperature detector 61, two different operation modes are set in the ROM 54. These operation modes can be switched by a mode signal MODE from the controller 55. In this embodiment, the ROM 54 and the controller 55 form a mode switching unit.

Specifically, a first operation mode to generate a head driving signal SD having a first frequency when a temperature T detected by the temperature detector 61 is equal to or lower than a predetermined temperature and a second operation mode to generate a head driving signal SD having a second frequency lower than the first frequency when the temperature T exceeds the predetermined temperature are set. In this embodiment, when the first operation mode (T≦40° C.) is employed, a driving signal having a driving frequency f_{D} (first frequency) (hereinafter this driving signal is referred to as “normal driving signal”) is generated. On the other hand, when the second operation mode (T>40° C.) is employed, a driving signal having a driving frequency ½f_{D} (second frequency), that is, a driving signal having a driving frequency that is ½ of the first frequency (hereinafter this driving signal is referred to as “high-temperature driving signal”) is generated.

Moreover, in this embodiment, when each operation mode is switched depending on the ambient temperature as described above, the moving velocity of the carriage 10 that reciprocates the recording head 9 in the primary scanning direction is changed on the basis of a control signal from the controller 55 that controls the rotation of the carriage motor 14. In this embodiment, the carriage motor 14 and the controller 55 serve as a head scanning controller.

Specifically, in the first operation mode, the controller 55 controls driving of the carriage motor 14 and the transport motor 15 so as to relatively move the recording head 9 and the print sheet P at a first velocity (the moving velocity of the carriage 10 in this case is V_{CR}). On the other hand, in the second operation mode, the controller 55 controls driving of the carriage motor 14 and the transport motor 15 so as to relatively move the recording head 9 and the print sheet P at a second velocity lower than the first velocity, in this embodiment, a second velocity that is ½ of the first velocity (that is, the moving velocity of the carriage 10 is ½V_{CR}).

In this manner, in the printer 1 according to this embodiment, when the first operation mode (T≦40° C.) is employed, the normal driving signal having the driving frequency f_{D} is generated and the moving velocity of the carriage 10 in this case is controlled to V_{CR}. On the other hand, when the second operation mode (T>40° C.) is employed, the high-temperature driving signal having the driving frequency ½f_{D} is generated and the moving velocity of the carriage 10 in this case is controlled to ½V_{CR}.

Hereinafter, specific operations of each circuit in the electric driving system 59 in each operation mode as described above will be described in detail.

First, the decoder 62 generates pulse selection data necessary for taking in a pulse waveform included in the common driving signal COM on the basis of print data inputted via the internal I/F 58. In this embodiment, it is assumed that a full ejection operation to eject ink droplets (so-called solid printing) is carried out. In this case, the decoder 62 generates pulse selection data based on print data corresponding to the solid printing.

In this case, the decoder 62 generates pulse selection data corresponding to each operation mode on the basis of the mode signal MODE. Specifically, in the first operation mode, the decoder 62 generates pulse selection data (1111) per cycle of the common driving signal COM corresponding to one pixel (hereinafter this cycle is referred to as “one segment”). On the other hand, in the second operation mode, the decoder 62 generates pulse selection data (1010) per segment of the common driving signal COM. In other words, in the second operation mode, the decoder 62 generates pulse selection data (10101010) per two segments of the common driving signal COM corresponding to one pixel.

The shift register circuit 63 sequentially and serially outputs each bit of the pulse selection data outputted from the decoder 62, synchronously with the clock signal CLK outputted from the oscillation circuit 56. The latch circuit 64 latches each bit of the pulse selection data outputted form the shift register circuit 63 by a latch signal LAT and thus generates a rectangular pulse train corresponding to each operation mode. This rectangular pulse train is supplied to the switch circuit 66 via the level shifter circuit 65. Then, the switch circuit 66 takes the logical product of the rectangular pulse train and the common driving signal COM and thus generates a driving signal corresponding to each operation mode (driving signal DS), that is, the normal driving signal having the driving frequency f_{D} in the first operation mode or the high-temperature driving signal having the driving frequency ½f_{D} in the second operation mode. In this embodiment, the driving signal generating circuit 57, the decoder 62, the shift register circuit 63, the latch circuit 64, the level shifter circuit 65 and the switch circuit 66 serve as a signal generator.

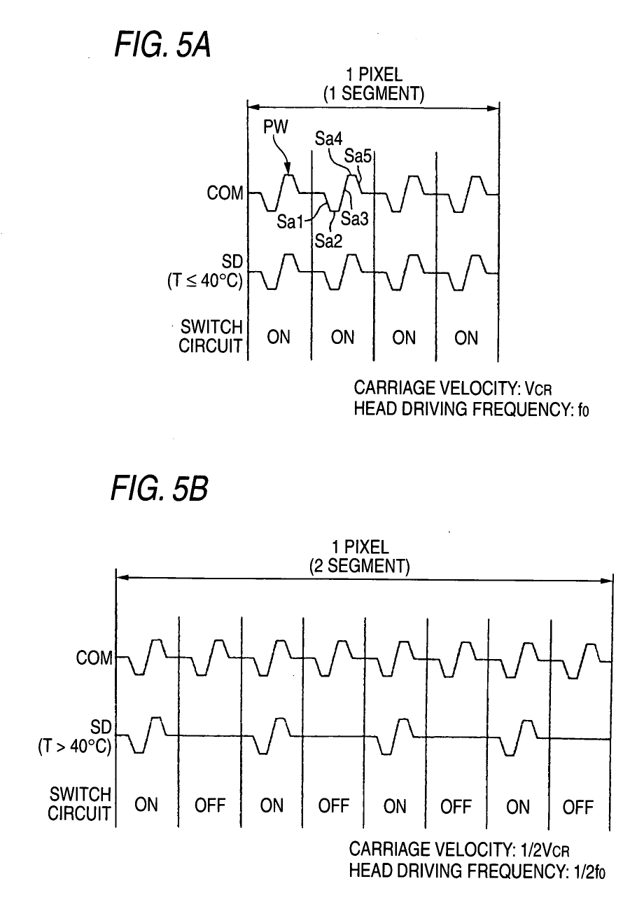

FIGS. 5A and 5B show the driving signals corresponding to each operation mode. Since it is assumed that the full ejection operation to eject ink droplets (solid printing) is carried out as described above, FIGS. 5A and 5B show the driving signals for controlling this solid printing.

In FIGS. 5A and 5B, the common driving signal COM is a signal common to each operation mode that is generated by the driving signal generating circuit 57 shown in FIG. 4. It is a signal including the same pulse waveform PW at equal intervals.

The pulse waveform PW has a first voltage decreasing part sa1 to supply a voltage to expand the pressure chamber 38 and reduce its internal pressure to the piezoelectric vibrator 31, a first voltage maintaining part sa2 to supply a voltage to maintain the reduced-pressure state to the piezoelectric vibrator 31, a first voltage increasing part sa3 to supply a voltage to contract the pressure chamber 38 and increase its internal pressure to the piezoelectric vibrator 31, a second voltage maintaining part sa4 to supply a voltage to maintain the increased-pressure state to the piezoelectric vibrator 31, and a second voltage decreasing part sa5 to supply a voltage to restore the original state of the pressure chamber 38 to the piezoelectric vibrator 31. This one pulse waveform PW causes each nozzle 37 to eject a quantity of ink droplet depending on the characteristics of the ink, and the mechanical characteristics, manufacturing errors and the like of the nozzle 37.

Hereinafter, the driving signal in each operation mode will be described.

As shown in FIG. 5A, in the first operation mode, the pulse selection data (1111) per segment of the common driving signal COM is outputted from the decoder 62, as described above. The switch circuit 66 takes the logical product of the rectangular pulse train generated on the basis of each bit of this pulse selection data (1111) and the common driving signal COM, and thus takes in the pulse waveform PW of the corresponding period from the common driving signal COM. That is, in the first operation mode, the switch circuit 66 takes in all the four pulse waveforms PW included in one segment of the common driving signal COM and thus generates the normal driving signal (SD) having the driving frequency f_{D} that is the same as the frequency of the common driving signal COM. Thus, in the first operation mode, four ink droplets are ejected into one pixel (corresponding to one segment) from the recording head 9, and if the unit pulse (PW) generating cycle of the common driving signal COM is, for example, 30 μs, the recording head 9 scans within the one pixel at 120 μs to form an image.

As shown in FIG. 5B, in the second operation mode, the pulse selection data (1010) per segment of the common driving signal COM is outputted from the decoder 62, as described above. The switch circuit 66 takes the logical product of the rectangular pulse train generated on the basis of each bit of this pulse selection data (1010) and the common driving signal COM, and thus takes in the pulse waveform PW of the corresponding period from the common driving signal COM. That is, in the second operation mode, the switch circuit 66 takes in every other pulse waveform of the four pulse waveforms PW included in one segment of the common driving signal COM and thus generates the high-temperature driving signal (SD) having the driving frequency ½f_{D} that is ½ of the frequency of the common driving signal COM. In this case, the moving velocity of the carriage 10 is controlled to ½ of the moving velocity in the first operation mode, as described above. Thus, also in the second operation mode, four ink droplets are ejected into one pixel (corresponding to two segments) from the recording head 9, as in the first operation mode, and if the unit pulse generating cycle of the common driving signal COM is, for example, 30 μs, as in the above-described case, the recording head 9 scans within the one pixel at 240 μs to form an image.

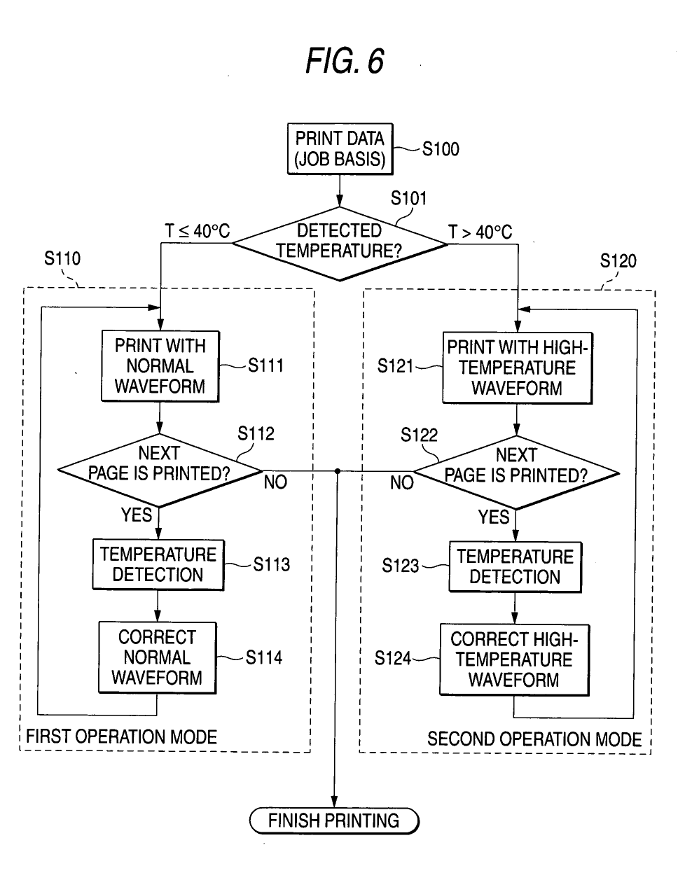

Next, head driving control of the printer 1 will be described with reference to FIG. 6. The head driving control is a control operation to optimize the driving signal supplied to the recording head 9 in accordance with the ambient temperature. Specifically, as will be described hereinafter, the head driving control is characterized in that the operation mode is changed in accordance with the ambient temperature at the time of use of the printer 1 (at this point, the moving velocity of the carriage 10 is changed, too) and that temperature correction is properly performed on the driving signal corresponding to the determined operation mode. This control routine is stored in the ROM 54 and executed by the controller 55 when receiving print data.

That is, as the controller 55 has received print data from the host computer or the like via the external I/F 52 (step S100), the controller 55 shifts the processing to this routine and executes the head driving control according to this embodiment. In this case, the print data received by the controller 55 is print data of each job.

As the controller 55 has received this print data of each job (print job), when starting printing based on the print job, the controller 55 acquires the temperature (ambient temperature) T in the peripheral region of the recording head 9 detected by the temperature detector 61 via the internal I/F 58 and judges whether the temperature T is equal to or lower than 40° C. or not, to decide the operation mode (step S101).

At this point, if it is judged that the temperature T is equal to or lower than 40° C., the controller 55 sets the first operation mode as the operation mode and subsequently executes printing in the first operation mode (step S110). On the other hand, if it is judged that the temperature T exceeds 40° C., the controller 55 sets the second operation mode as the operation mode and subsequently executes printing in the second operation mode (step S120).

Here, in the case where T≦40° C. holds and the first operation mode is executed, the controller 55 causes the normal driving signal to be generated in the electric driving system 59 and supplied to each piezoelectric vibrator 31 of the recording head 9, and causes the recording head 9 to eject ink droplets, thus executing printing (step S111). On the common driving signal COM, which is the original signal for generating the normal driving signal in this case, temperature correction such as potential correction and duration correction in accordance with the ambient temperature (temperature T) is performed by the controller 55 on the basis of the table stored in the ROM 54. The normal driving signal generated on the basis of the common driving signal COM on which the temperature correction has been performed is supplied to each piezoelectric vibrator 31 of the recording head 9.

As the printing on the print sheet P of one page is completed by the normal driving signal on which the temperature correction has been performed, the controller 55 then confirms the content of the print job and judges whether the print job includes an instruction to execute printing of the next page or not (step S112). In short, the controller 55 judges whether the print job instructs it to print plural pages or not.

Here, if it is judged that the print job does not include the next page, the controller 55 terminates printing. On the other hand, if it is judged that the print job includes the next page, when starting printing the second page, the controller 55 acquires the temperature T in the peripheral region of the recording head 9 detected by the temperature detector 61 again (step S113). Then, the controller 55 causes the normal driving signal to be generated again on the basis of the common driving signal COM on which the temperature correction has been performed in accordance with the newly acquired temperature T (step S114), then causes the normal driving signal to be supplied to each piezoelectric vibrator 31 of the recording head 9, and causes the recording head 9 to eject ink droplets, thus executing printing of the second page.

After that, the controller 55 shifts to the above-described step S112 to check the print job again. If it is judged in this judgment processing that there is an instruction to print the next page, the controller 55 performs the processing of the above-described steps S113 and S114, as described above. By repeating such a series of processing for plural pages designated by the job, the controller 55 executes printing in the first operation mode.

Meanwhile, in the case where T>40° C. holds and the second operation mode is executed, the controller 55 causes the high-temperature driving signal to be generated in the electric driving system 59 and supplied to each piezoelectric vibrator 31 of the recording head 9 and causes the recording head 9 to eject ink droplets, thus executing printing (step S121). On the common driving signal COM, which is the original signal for generating the high-temperature driving signal in this case, temperature correction such as potential correction and duration correction in accordance with the ambient temperature (temperature T) is performed by the controller 55 as in the above-described first operation mode. The high-temperature driving signal generated on the basis of the common driving signal COM on which the temperature correction has been performs is supplied to each piezoelectric vibrator 31 of the recording head 9. Since the moving velocity of the carriage in this case is controlled to ½ of the moving velocity in the first operation mode, as described above, printing takes a scanning time per pixel that is twice the scanning time in the first operation mode.

As the printing on the print sheet P of one page is completed by the high-temperature driving signal on which the temperature correction has been performed, the controller 55 then confirms the content of the print job and judges whether the print job includes an instruction to execute printing of the next page or not (step S122).

Here, if it is judged that the print job does not include the next page, the controller 55 terminates printing. On the other hand, if it is judged that the print job includes the next page, when starting printing the second page, the controller 55 acquires the temperature T in the peripheral region of the recording head 9 detected by the temperature detector 61 again (step S123). Then, the controller 55 causes the high-temperature driving signal to be generated again on the basis of the common driving signal COM on which the temperature correction has been performed in accordance with the newly acquired temperature T (step S124), then causes the high-temperature driving signal to be supplied to each piezoelectric vibrator 31 of the recording head 9, and causes the recording head 9 to eject ink droplets, thus executing printing of the second page.

After that, the controller 55 shifts to the above-described step S122 to check the print job again. If it is judged in this judgment processing that there is an instruction to print the next page, the controller 55 performs the processing of the above-described steps S123 and S124. By repeating such a series of processing for plural pages designated by the job, the controller 55 executes printing in the second operation mode.

As can be understood from the above description, in the head driving control according to this embodiment, temperature correction is performed for each page until printing based on one received print job terminates, but the initially decided operation mode remains unchanged. In other words, once the operation mode is decided in executing printing based on one print job, the driving frequency of the recording head 9 and the moving velocity of the carriage 10 are not changed during the execution.

The reason for employing such a control mode is that if the moving velocity of the carriage 10 is changed during the execution of printing based on one print job, difference in image quality, color difference and the like due to the change in the carriage velocity may occur. The applicant has experimentally confirmed that the occurrence of the difference in image quality, color difference and the like is due to the change in the carriage velocity rather than the ambient temperature.

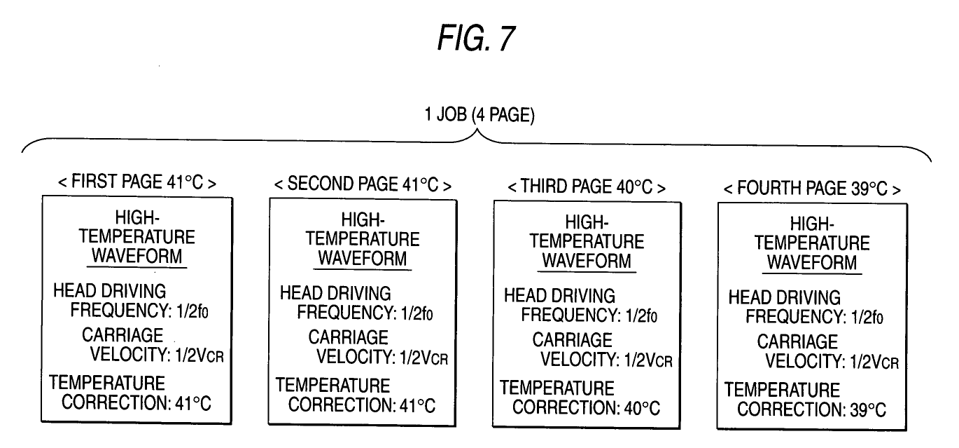

Therefore, for example, in the case where one received print job includes an instruction to print four pages, since the ambient temperature detected when executing printing of the first page is 41° C., the first page is printed on the basis of the high-temperature driving signal, and irrespective of the ambient temperature detected after that, printing of the four pages is executed on the basis of the high-temperature driving signal, as shown in FIG. 7.

That is, if the ambient temperature detected at the time of printing the first page is, for example, 41° C., the printing of the first page is performed by using the high-temperature driving signal on which temperature correction corresponding to 41° C. has been performed (second operation mode: carriage velocity ½V_{CR} and driving frequency ½f_{D}).

Next, if the ambient temperature detected at the time of printing the second page is 41° C., the printing of the second page is performed by using the high-temperature driving signal on which temperature correction corresponding to 41° C. has been performed (second operation mode: carriage velocity ½V_{CR} and driving frequency ½f_{D}), as in the case of the first page.

Next, if the ambient temperature detected at the time of printing the third page is 40° C., the printing of the third page is performed by using the high-temperature driving signal on which temperature correction corresponding to 40° C. has been performed (second operation mode: carriage velocity ½V_{CR} and driving frequency ½f_{D}). In short, even in the case where the ambient temperature detected at the time of printing the third page is 40° C., the operation mode is not switched to the first operation mode and the printing is performed by using the high-temperature driving signal on which only the temperature correction has been performed.

Next, if the ambient temperature detected at the time of printing the fourth page is 39° C., the printing of the fourth page is performed by using the high-temperature driving signal on which temperature correction corresponding to 39° C. has been performed (second operation mode: carriage velocity ½V_{CR} and driving frequency ½f_{D}). In short, also in this case, the operation mode is not switched to the first operation mode and the printing is performed by using the high-temperature driving signal on which only the temperature correction has been performed.

Although not described specifically here, in the case where one print job similarly includes an instruction to print plural pages, after the first page is printed by using the normal driving signal (first operation mode: carriage velocity V_{CR} and driving frequency f_{D}), printing of all the pages is executed by using the normal driving signal irrespective of the ambient temperature detected after that.

In this connection, in the printer 1 of this embodiment, which is used as it is housed in a rack or the like, even when the ambient temperature at the time of use (at the time of starting printing of the first page) is a high temperature exceeding 40° C., the cooling fan (not shown) provided in the printer 1 is driven to radiate the heat filling the rack or the like and the temperature tends to be lowered gradually. Therefore, it is considered that after the printing the first page is started by using the normal driving signal in the first operation mode, the temperature cannot rise to be higher than 40° C. later. Accordingly, it is considered that switching to the second operation mode during the printing is rarely necessary.

As described above, this embodiment has the following advantages.

(1) When the temperature T in the peripheral region of the recording head 9 detected by the temperature detector 61 as the ambient temperature at the time of using the printer 1 is equal to or lower than a predetermined temperature (for example, 40° C.), the printer 1 executes the first operation mode to move the carriage 10 at the carriage velocity V_{CR} while supplying the normal driving signal (SD) having the driving frequency f_{D} to the recording head 9 and causing the recording head 9 to eject ink droplets. On the other hand, when the temperature T detected by the temperature detector 61 exceeds 40° C., the printer 1 executes the second operation mode to move the carriage 10 at the carriage velocity ½V_{CR} while supplying the high-temperature driving signal (SD) having the driving frequency ½f_{D} to the recording head 9 and causing the recording head 9 to eject ink droplets. Thus, when the environment where the printer 1 is used is a high-temperature environment exceeding 40° C., the recording head 9 can be driven by the head driving signal SD having the relatively lower frequency than the frequency in normal driving (when the temperature is 40° C. or lower) and the ejection interval of ink droplets ejected from the recording head 9 can be made longer. Consequently, even in the high-temperature environment where the viscosity of ink is lowered, residual vibration due to the meniscus and the like can be properly restrained (because a long periodic damping time can be taken) and ink droplets can be ejected stably. In other words, it is possible to set the ambient temperature that can be guaranteed at the time of using the printer 1, to a higher value. That is, while the maximum ambient temperature at which ink droplets can be stably ejected is 40° C. in the conventional technique, an ambient temperature higher than 40° C. can be set in this embodiment.

(2) In this embodiment, the high-temperature driving signal in the second operation mode is generated with a relatively lower frequency so that the pulse spacing becomes longer than that of the normal driving signal in the first operation mode. In this manner, as the pulse spacing of the driving signal generated when the temperature is high is made longer than when the temperature is normal, the ejection interval of ink droplets can be made longer in the high-temperature environment where the viscosity of ink is lowered, and ink droplets can be ejected stably.

(3) In this embodiment, as the driving frequency of the recording head 9 in the second operation mode is set to ½ of the driving frequency in the first operation mode, the moving velocity of the carriage 10 is accordingly set to ½ of the moving velocity in the first operation mode. Thus, the number of ink droplets ejected per pixel in one scanning operation by the recording head 9 can be made equal in the first operation mode and the second operation mode. Therefore, whichever operation mode is used for driving the recording head 9, similar print image quality can be realized.

(4) In this embodiment, once one of the operation modes is decided at the start of printing based on one print job, even if the ambient temperature varies later between temperature regions corresponding to the individual operation modes, the operation mode is not switched until the printing based on the one print job is completed. Thus, since the moving velocity of the recording head 9 is not changed during the printing based on the one print job, occurrence of difference in print image quality, color difference and the like due to change in the moving velocity can be prevented.

(5) In this embodiment, in addition to executing the switching control of each operation mode in accordance with the ambient temperature, temperature correction according to the ambient temperature is performed on each pulse waveform of the driving signal generated in each operation mode. In this case if a print job includes an instruction to execute printing of plural pages, the temperature correction corresponding to each ambient temperature is properly performed for each page. Thus, the ejection stability of ink droplets can be further improved.

In this embodiment, the normal driving signal generated in the first operation mode and the high-temperature driving signal generated in the second operation mode are generated by using the common driving signal COM that is common to these modes. The technique for generating the high-temperature driving signal is not limited to this technique. For example, when the second operation mode is employed, pulse selection data (1111) similar to that in the first operation mode may be outputted from the decoder 62, and the common driving signal COM may be recorded in advance to the ROM 54 separately for the normal driving signal and for the high-temperature driving signal so that the common driving signal COM for the high-temperature driving signal has a pulse spacing twice longer than the pulse spacing of the common driving signal COM for the normal driving signal, thus generating the high-temperature driving signal.

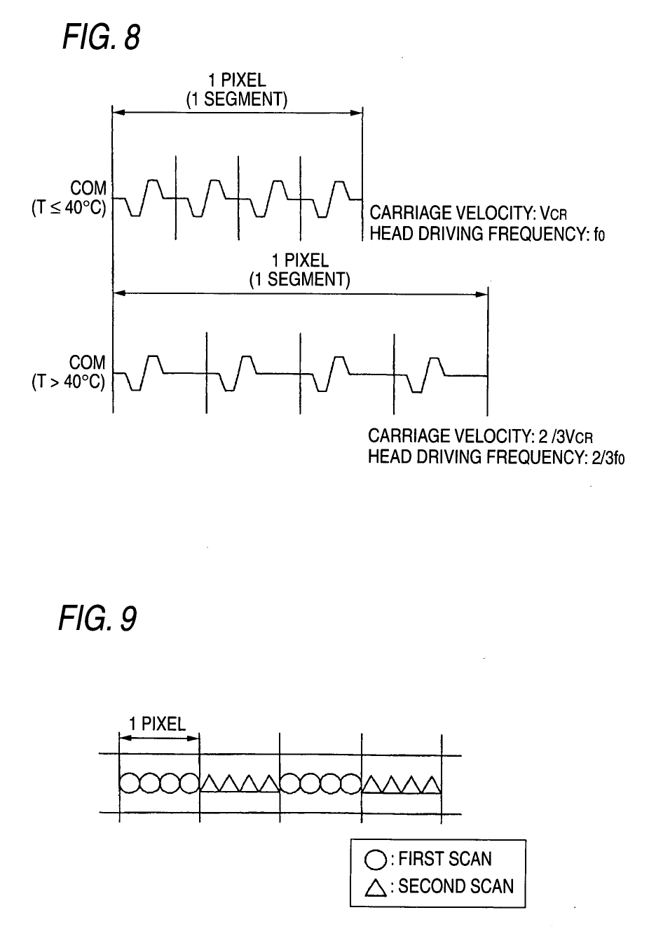

In this case, as the pulse spacing of the common driving signal COM is changed, the change in the frequency is not necessarily limited to ½ of the frequency of the normal driving signal, and a high-temperature driving signal having a ⅔-, ¾- or like frequency can be generated. For example, in FIG. 8, the pulse spacing of the common driving signal COM for the high-temperature driving signal is changed (that is, the common driving signal COM for the high-temperature driving signal has a pulse spacing that is 1.5 times that of the common driving signal COM for the normal driving signal) so that the high-temperature driving signal has a frequency that is ⅔ of the frequency of the normal driving signal. In this case, as the frequency is changed to ⅔, the carriage velocity is similarly changed to ⅔, too.

In this embodiment, the frequency of the high-temperature driving signal generated in the second operation mode is set to ½ of the frequency of the normal driving signal generated in the first operation mode, and the moving velocity of the carriage 10 in the second operation mode is accordingly changed to ½ of the moving velocity in the first operation mode. However, these changes are not limited to ½. That is, if the frequency of the high-temperature driving signal generated in the second operation mode is 1/N (where N is an integer larger than 1) of the frequency of the normal driving signal generated in the first operation mode, the moving velocity of the carriage can be accordingly changed to 1/N, too.

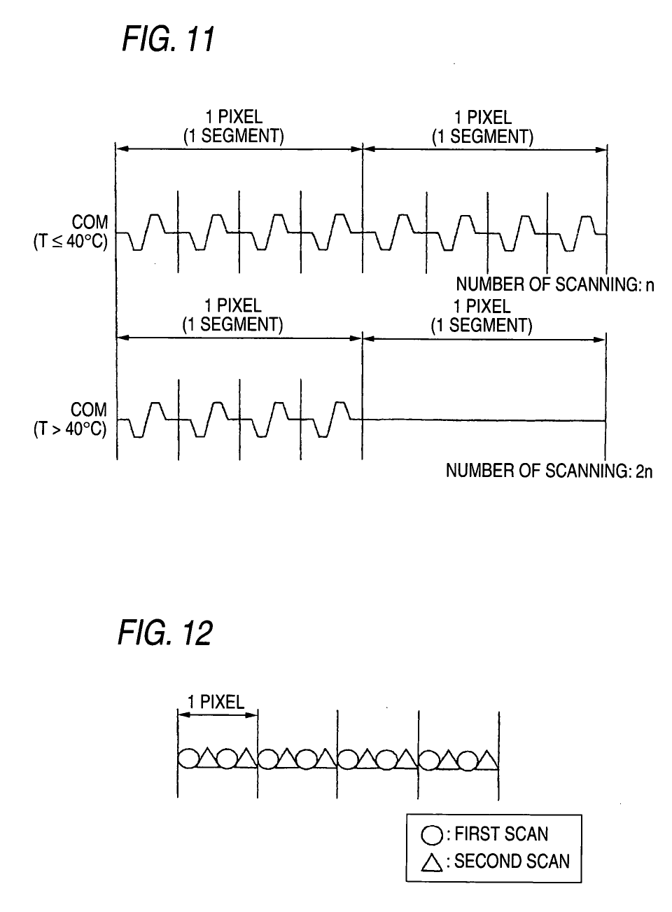

Next, a second embodiment of this invention will be described with reference to FIGS. 9 to 11. The parts common to those of the first embodiment are denoted by the same reference numerals and will not be described further in detail.

In this embodiment, in order to generate such a head driving signal SD with a waveform depending on the temperature in the peripheral region of the recording head 9 detected by the temperature detector 61, two different operation modes are set in the ROM 54 and these operation modes are switched by the mode signal MODE from the controller 55. In this embodiment, the ROM 54 and the controller 55 form a mode switching unit.

Specifically, when the temperature T detected by the temperature detector 61 is equal to or lower than a predetermined temperature (for example, 40° C.), the controller 55 executes a first operation mode to generate a first driving signal (hereinafter referred to as “normal driving signal”) based on a driving signal COM, in accordance with dot pattern data read out from the output buffer (RAM 53). In this case, the controller 55 performs temperature correction corresponding to the temperature T on each pulse waveform of the driving signal COM and generates the normal driving signal based on this corrected driving signal COM.

On the other hand, when the temperature T detected by the temperature detector 61 exceeds the predetermined temperature (40° C.), the controller 55 executes a second operation mode to a second driving signal (hereinafter referred to as “high-temperature driving signal”) so that the ejection operation by the recording head 9 based on the dot pattern data is performed in a predetermined interval cycle, in this embodiment, every other pixel. Specifically, the high-temperature driving signal is generated by generating a pulse train included in one segment of the driving signal COM corresponding to one pixel, once every two segments. In this case, as in the first operation mode, the controller 55 performs temperature correction corresponding to the temperature T on each pulse waveform of the driving signal COM and generates the high-temperature driving signal based on this corrected driving signal COM.

In this embodiment, the cycle of each generated pulse waveform (pulse cycle) is made equal in the normal driving signal and the high-temperature driving signal, and the moving velocity of the carriage 10 (that is, moving velocity of the recording head 9) is equal in the first operation mode and the second operation mode. This is because if the moving velocity of the recording head 9 is changed, difference in ink penetration due to the change in the ejection timing of ink droplets may appear as color difference.

Meanwhile, in the second operation mode as described above, since the ink droplet ejection operation by the recording head 9 is performed every other pixel in one primary scanning operation by the recording head 9, the controller 55 changes the number of times of scanning by the recording head 9 in the second operation mode to twice the number of times of scanning in the first operation mode. As the number of times of scanning by the recording head 9 is thus doubled, the ejection operation for pixels at which ink droplets have not been ejected by the first scanning, in the recording region corresponding to the one scanning operation by the recording head 9, is compensated by the second scanning.

That is, for example, in the case where ink droplet ejection is performed four times per pixel, in the second operation mode, first, ink droplets are ejected every other pixel as the recording head 9 moves forward in the first scanning, as shown in FIG. 9. Then, the second scanning is performed at the same position as in the first scanning, and as the recording head moves forward in this second scanning, ink droplets are ejected every other pixel at pixels to which ink droplets have not been ejected in the first scanning. Then, after this second scanning is completed, the print sheet P is fed in the secondary scanning direction.

In this manner, in the printer 1 according to this embodiment, the ejection operation in the recording region corresponding to one scanning operation is performed by two scanning operations of the recording head 9 and the sheet feeding operation of the print sheet P is performed once every two scanning operations of the recording head 9.

The printer 1 of this embodiment is adapted for ejecting ink droplets as the recording head 9 moves forward and thus performing recording (unidirectional printing). However, it is possible to apply this driving system to a printer that performs recording as the recording head 9 moves both forward and backward (bi-directional printing). In the printer performing such bi-directional printing, the ejection operation for pixels that have not been recorded when the recording head moves forward is compensated when recording head moves backward.

Hereinafter, specific operations of each circuit in the electric driving system 59 in each operation mode as described above will be described in detail.

First, the decoder 62 generates pulse selection data necessary for taking in a pulse waveform in the driving signal COM on the basis of print data SI inputted via the internal I/F 58. In this embodiment, it is assumed that a full ejection operation to eject ink droplets (so-called solid printing) is performed. In this case, the decoder 62 generates pulse selection data based on the print data SI corresponding to the solid printing.

At this point, the decoder 62 generates pulse selection data corresponding to each operation mode on the basis of the mode signal MODE.

Specifically, when the first operation mode is employed, the decoder 62 generates pulse selection data (1111) per segment of the driving signal COM corresponding to one pixel on the basis of the print data SI corresponding to the solid printing. On the other hand, when the second operation mode is employed, the decoder 62 alternately generates pulse selection data (1111) and pulse selection data (0000) per segment of the driving signal COM. In other words, in the second operation mode, the decoder 62 generates pulse selection data (11110000) per two segments of the driving signal COM.

The shift register circuit 63 sequentially and serially outputs each bit of the pulse selection data outputted from the decoder 62, synchronously with a clock signal CLK outputted from the oscillation circuit 56. The latch circuit 64 latches each bit of the pulse selection data outputted from this shift register circuit 63 by a latch signal LAT and thereby generates a rectangular pulse train corresponding to each operation mode. This rectangular pulse train is supplied to the switch circuit 66 via the level shifter circuit 65. Then, the switch circuit 66 takes the logical product of the rectangular pulse train and the driving signal COM and thus generates the driving signal corresponding to each operation mode. In this embodiment, the driving signal generating circuit 57, the decoder 62, the shift register circuit 63, the latch circuit 64, the level shifter circuit 65 and the switch circuit 66 serve a signal generator.

Hereinafter, the driving signal in each operation mode in this embodiment will be described.

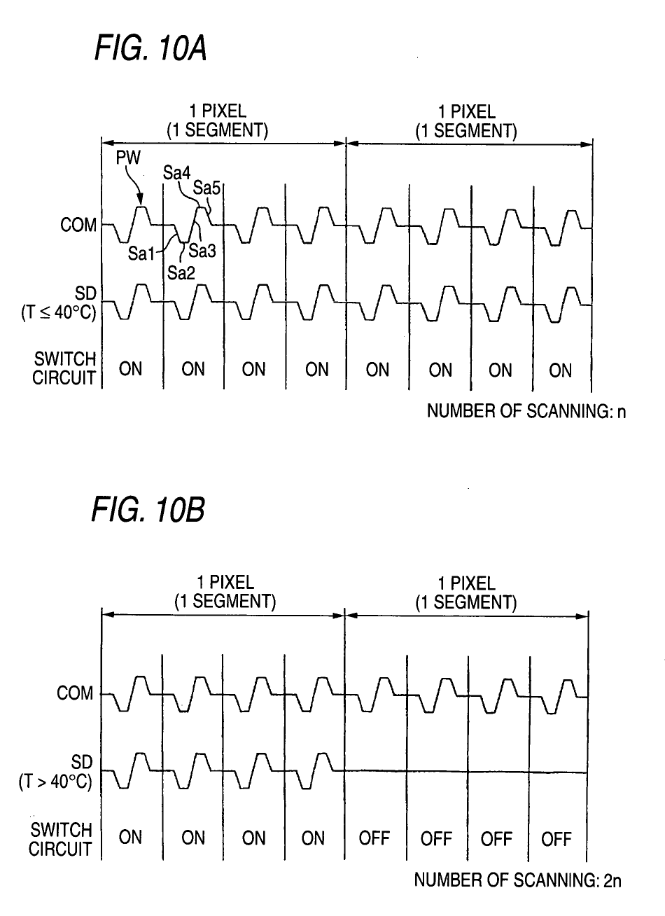

In the first operation mode, as shown in FIG. 10A, the pulse selection data (1111) per segment of the driving signal COM is outputted from the decoder 62. The switch circuit 66 takes the logical product of the rectangular pulse train generated on the basis of each bit of the pulse selection data and the driving signal COM and thereby takes in the pulse waveform PW of the corresponding period from the driving signal COM. That is, in this first operation mode, the switch circuit 66 generates the normal driving signal (SD) by taking in all the pulse waveforms PW in the driving signal COM.

In the second operation mode, as shown in FIG. 10B, the pulse selection data (1111) and the pulse selection data (0000) are alternately outputted from the decoder 62 per segment of the driving signal COM. The switch circuit 66 takes the logical product of the rectangular pulse train generated on the basis of each bit of the pulse selection data and the driving signal COM and thereby takes in the pulse waveform PW of the corresponding period from the driving signal COM. That is, in this second operation mode, the switch circuit 66 generates the high-temperature driving signal (SD) by taking in each pulse waveform in the driving signal COM every other segment. In this case, the number of times of scanning by the recording head 9 is controlled to (2n), which is twice the number of times of scanning (n) in the first operation mode, as described above. Therefore, in the second operation mode, recording is performed in a scanning time (print time) that is twice the scanning time in the first operation mode.

In the head driving control in this embodiment, the operation mode is changed in accordance with the ambient temperature at the time of using the printer 1, and at this point, the number of times of scanning by the recording head 9 is changed, too.

In the case of executing the second operation mode, the controller 55 causes the high-temperature driving signal to be generated in the electric driving system 59, then causes the high-temperature driving signal to be supplied to each piezoelectric vibrator 31 of the recording head 9, and causes the recording head 9 to eject ink droplets, thus executing printing (step S121 in FIG. 7). Since the number of times of scanning by the recording head 9 in this case is twice the number of time of scanning in the first operation mode as described above, printing is performed in a scanning time (print time) that is twice the scanning time in the first operation mode.

In the head driving control according to this embodiment, temperature correction is perform for every page until printing based on one received print job is completed, but the operation mode that is decided at the beginning is left unchanged. In other words, once the operation mode is decided in execution of printing based on one print job, the driving waveform of the recording head 9 is not changed during the execution.

The reason for employing such a control mode is that if the operation mode (driving signal) is changed during printing based on one print job, difference in ink penetration due to the change in scanning time (print time) may appear as color difference. The applicant has experimentally confirmed that the occurrence of such color difference depends largely on the ink penetration (that is, time difference) rather than the change in the ambient temperature.

The structure of this embodiment has the following advantages. The other advantages than the following are similar to those described with reference the first embodiment. (1) When the temperature T in the peripheral region of the recording head 9 detected by the temperature detector 61 as the ambient temperature at the time of using the printer 1 is equal to or lower than a predetermined temperature (for example, 40° C.), the printer 1 executes the first operation mode to taken in each pulse waveform in the driving signal COM and generate the normal driving signal. On the other hand, when the temperature T detected by the temperature detector 61 exceeds the above-described temperature 40° C., the printer 1 executes the second operation mode to take in each pulse waveform in the driving signal COM every other segment and generate the high-temperature driving signal (SD), so that the ink droplet ejection operation by the recording head 9 is performed every other pixel. Generally, residual vibration of the meniscus after ink droplets are ejected increases in a high-temperature environment where the viscosity of ink is lowered, and as ink droplets are continuously ejected at high response (short ejection intervals), the residual vibration is superimposed. In this embodiment, when the environment where the printer 1 is used is high-temperature environment exceeding, for example, 40° C. as described above, the ejection operation by the recording head 9 is performed every other pixel, and therefore, even in the high-temperature environment where the viscosity is lowered, the residual vibration of the meniscus superimposed by the continuous ejection of ink droplets can be properly damped by utilizing the period in which the ejection operation is not performed. Consequently, it is possible to stably eject ink droplets and it is possible to set the ambient temperature that can be guaranteed at the time of using the printer 1, to a higher value. That is, while the maximum ambient temperature at which ink droplets can be stably ejected is 40° C. in the conventional technique, an ambient temperature higher than 40° C. can be set in this embodiment.

(2) In this embodiment, as the moving velocity of the carriage 10 (moving velocity of the recording head 9) is kept constant in each operation mode, occurrence of color difference due to difference in ink penetration caused by changes in ink droplet ejection timing or occurrence of difference in image quality due to errors of ink droplet landing position can be restrained.

In this embodiment, the normal driving signal generated in the first operation mode and the high-temperature driving signal generated in the second operation mode are generated by using the common driving signal COM. However, the technique for generating the high-temperature driving signal is not limited to this technique. For example, when the second operation mode is employed, the pulse selection data (1111) as in the first operation mode may be outputted from the decoder 62, and the driving signal COM may be recorded in advance to the ROM 54 separately for the normal driving signal and for the high-temperature driving signal, and the common driving signal COM for the high-temperature driving signal is generated so that the ink droplet ejection operation by the recording head 9 is performed every other pixel, thus generating the high-temperature driving signal.

In this embodiment, the high-temperature driving signal is generated so that the ink droplet ejection operation by the recording head 9 is performed every other pixel, but it does not always have to be performed every other pixel. For example, after the ejection operation for two pixels is performed, the ejection operation may be stopped for the next two pixels. Moreover, ink droplets need not be always ejected pixel by pixel. That is, in this invention, in order to damp the residual vibration of the meniscus superimposed by the continuous ejection of ink droplets in the high-temperature environment where the viscosity is lowered, the high-temperature driving signal is generated so that the ejection operation by the recording head 9 is performed in a predetermined interval cycle.

Next, a third embodiment of this invention will be described with reference to FIGS. 12 to 14. The parts common to those of the second embodiment are denoted by the same reference numerals and will not be described further in detail.

When the temperature T detected by the temperature detector 61 is equal to or lower than a predetermined temperature (for example, 40° C.), the controller 55 in this embodiment executes a first operation mode to generate a first driving signal (hereinafter referred to as “normal driving signal”) having a driving frequency f_{D} (first frequency) based on a driving signal COM, in accordance with dot pattern data read out from the output buffer (RAM 53). In this case, the controller 55 performs temperature correction corresponding to the temperature T on each pulse waveform of the driving signal COM and generates the normal driving signal based on this corrected driving signal COM.

On the other hand, when the temperature T detected by the temperature detector 61 exceeds the predetermined temperature (40° C.), the controller 55 executes a second operation mode to a second driving signal (hereinafter referred to as “high-temperature driving signal”) having a driving frequency that is ½ times the first frequency, that is, a driving frequency ½f_{D} (second frequency). In this case, as in the first operation mode, the controller 55 performs temperature correction corresponding to the temperature T on each pulse waveform of the driving signal COM and generates the high-temperature driving signal based on this corrected driving signal COM.

In this embodiment, the moving velocity of the carriage 10 for reciprocating the recording head 9 in the primary scanning direction is held constant in the first operation mode and the second operation mode. This is because if the moving velocity of the carriage 10 (the moving velocity of the recording head 9) is changed, color difference due to difference in ink penetration caused by a change in the ink droplet ejection timing or difference in image quality due to an error in ink droplet landing position may occur.

Therefore, in the second operation mode in which the driving frequency is set to ½ times the driving frequency in the first operation mode as described above, the number of ink droplets ejected from the recording head 9 is half the number of ink droplets in the first operation mode in one primary scanning operation by the recording head 9. Therefore, in this embodiment, the controller 55 changes the number of times of scanning by the recording head 9 in the second operation mode to twice the number of times of scanning in the first operation mode. As the number of times of scanning by the recording head 9 is thus doubled, the ejection operation for pixels at which ink droplets have not been ejected by the first scanning, in the recording region corresponding to the one scanning operation by the recording head 9, is compensated by the second scanning.

That is, for example, in the case where ink droplet ejection is performed four times per pixel, in the second operation mode, first, ink droplets are ejected every other ink droplet as the recording head 9 moves forward in the first scanning, as shown in FIG. 12. Then, the second scanning is performed at the same position as in the first scanning, and as the recording head moves forward in this second scanning, ink droplets are similarly ejected every other ink droplet at pixels to which ink droplets have not been ejected in the first scanning. Then, after this second scanning is completed, the print sheet P is fed in the secondary scanning direction.

In this manner, In the printer 1 according to this embodiment, the ejection operation in the recording region corresponding to one scanning operation is performed by two scanning operations of the recording head 9, and the sheet feeding operation of the print sheet P is performed once every two scanning operations of the recording head 9.

The printer 1 of this embodiment is adapted for ejecting ink droplets as the recording head 9 moves forward and thus performing recording (unidirectional printing). However, it is possible to apply this driving system to a printer that performs recording as the recording head 9 moves both forward and backward (bi-directional printing). In the printer performing such bi-directional printing, the ejection operation for pixels that have not been recorded when the recording head moves forward is compensated when recording head moves backward.

Hereinafter, specific operations of each circuit in the electric driving system 59 in each operation mode as described above will be described in detail.

First, the decoder 62 generates pulse selection data necessary for taking in a pulse waveform in the driving signal COM on the basis of print data SI inputted via the internal I/F 58. In this embodiment, it is assumed that a full ejection operation to eject ink droplets (so-called solid printing) is performed. In this case, the decoder 62 generates pulse selection data based on the print data SI corresponding to the solid printing.

At this point, the decoder 62 generates pulse selection data corresponding to each operation mode on the basis of the mode signal MODE. Specifically, when the first operation mode is employed, the decoder 62 generates pulse selection data (1111) per segment of the driving signal COM corresponding to one pixel on the basis of the print data SI corresponding to the solid printing. On the other hand, when the second operation mode is employed, the decoder 62 generates pulse selection data (1010) per segment of the driving signal COM.

The shift register circuit 63 sequentially and serially outputs each bit of the pulse selection data outputted from the decoder 62, synchronously with a clock signal CLK outputted from the oscillation circuit 56. The latch circuit 64 latches each bit of the pulse selection data outputted from this shift register circuit 63 by a latch signal LAT and thereby generates a rectangular pulse train corresponding to each operation mode. This rectangular pulse train is supplied to the switch circuit 66 via the level shifter circuit 65.

Then, the switch circuit 66 takes the logical product of the rectangular pulse train and the driving signal COM and thus generates the driving signal (head driving signal SD) corresponding to each operation mode, that is, the normal driving signal having the driving frequency f_{D} in the first operation mode or the high-temperature driving signal having the driving frequency ½f_{D} in the second operation mode. In this embodiment, the driving signal generating circuit 57, the decoder 62, the shift register circuit 63, the latch circuit 64, the level shifter circuit 65 and the switch circuit 66 serve as a signal generator.

Hereinafter, the driving signal in each operation mode in this embodiment will be described.

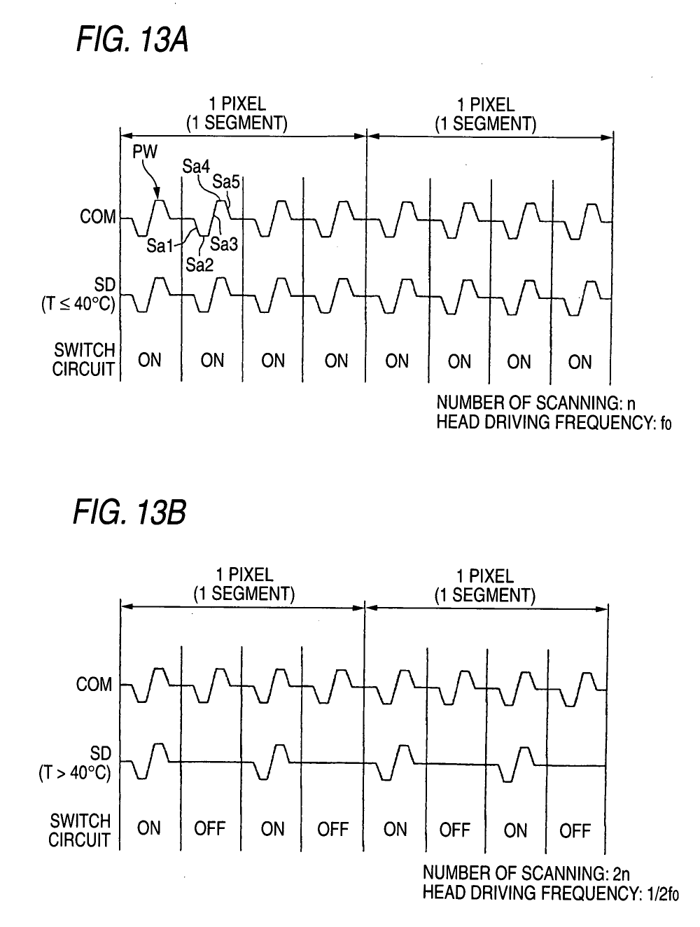

In the first operation mode, as shown in FIG. 13A, the pulse selection data (1111) per segment of the driving signal COM is outputted from the decoder 62. The switch circuit 66 takes the logical product of the rectangular pulse train generated on the basis of each bit of the pulse selection data and the driving signal COM and thereby takes in the pulse waveform PW of the corresponding period from the driving signal COM. That is, in this first operation mode, the switch circuit 66 generates the normal driving signal (SD) having the driving frequency f_{D} by taking in all the pulse waveforms PW in the driving signal COM.

In the second operation mode, as shown in FIG. 13B, the pulse selection data (1010) per segment of the driving signal COM is outputted from the decoder 62. The switch circuit 66 takes the logical product of the rectangular pulse train generated on the basis of each bit of the pulse selection data and the driving signal COM and thereby takes in the pulse waveform PW of the corresponding period from the driving signal COM. That is, in this second operation mode, the switch circuit 66 generates the high-temperature driving signal (SD) having the driving frequency ½f_{D} by taking in every other pulse waveform in the driving signal COM.

When this second operation mode is employed, the moving velocity of the carriage 10 (moving velocity of the recording head 9) is controlled to the same moving velocity as in the first operation mode, and the number of times of scanning by the recording head 9 is controlled to (2n), which is twice the number of times of scanning (n) in the first operation mode, as described above. Therefore, in the second operation mode, recording is performed in a scanning time (print time) that is twice the scanning time in the first operation mode.

As described above, the structure of this embodiment has the following advantages. The other advantages than the following are similar to those described with reference the above-described embodiments.

When the temperature T in the peripheral region of the recording head 9 detected by the temperature detector 61 as the ambient temperature at the time of using the printer 1 is equal to or lower than a predetermined temperature (for example, 40° C.), the printer 1 executes the first operation mode to taken in each pulse waveform in the driving signal COM and generate the normal driving signal having the driving frequency f_{D}. On the other hand, when the temperature T detected by the temperature detector 61 exceeds the above-described temperature 40° C., the printer 1 executes the second operation mode to take in every other pulse waveform in the driving signal COM and generate the high-temperature driving signal (SD) having the driving frequency ½f_{D}. Then, the moving velocity of the recording head 9 is the same velocity in each operation mode, and in the second operation mode, the number of times of scanning by the recording head 9 is twice the number of times of scanning in the first operation mode.

Residual vibration of the meniscus after ink droplets are ejected increases in a high-temperature environment where the viscosity of ink is lowered, and as ink droplets are continuously ejected at high response (short ejection intervals), the residual vibration is superimposed. In this embodiment, in the view of the above, when the environment where the printer 1 is used is high-temperature environment exceeding, for example, 40° C. as described above, the recording head 9 is driven by the driving signal (SD) having the relatively lower frequency than in the normal-temperature environment (40° C. or lower). Thus, the ejection interval of ink droplets ejected from the recording head 9 can be made longer and enough time to enable damping of the residual vibration of the meniscus can be secured. Therefore, the residual vibration of the meniscus can be properly restrained even in the high-temperature environment and the ink droplet ejection stability can be improved. In other words, it is possible to set the ambient temperature that can be guaranteed at the time of using the printer 1, to a higher value. That is, while the maximum ambient temperature at which ink droplets can be stably ejected is 40° C. in the conventional technique, an ambient temperature higher than 40° C. can be set in this embodiment.

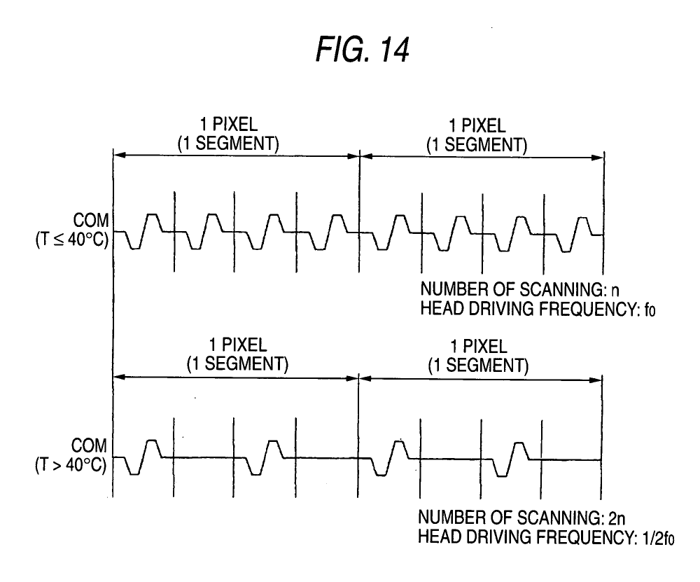

In this embodiment, the normal driving signal generated in the first operation mode and the high-temperature driving signal generated in the second operation mode are generated by using the common driving signal COM. However, the technique for generating the high-temperature driving signal is not limited to this technique. For example, the driving signal COM is recorded in advance to the ROM 54 separately for the normal driving signal and for the high-temperature driving signal, and the common driving signal COM for the high-temperature driving signal is generated at a pulse spacing that is twice the pulse spacing of the driving signal COM for the normal driving signal, as shown in FIG. 14. Then, when the second operation mode is employed, pulse selection data (11) per segment may be outputted from the decoder 62, thus generating the high-temperature driving signal.

In this embodiment, when the second operation mode is employed, the recording head 9 is driven by the second driving signal having the second frequency (driving frequency ½f_{D}) set to ½ of the first frequency (driving frequency f_{D}). However, the second frequency is not necessarily limited to ½. That is, the second frequency may be set to any lower frequency than the first frequency, specifically, 1/N times the first frequency (where N>1). In the case where the second frequency is thus set to 1/N times the first frequency, the moving velocity of the recording head 9 in the second operation mode is set to 2/N times the moving velocity in the first operation mode. In this case, the number of times of scanning by the recording head 9 in the second operation mode is twice the number of times of scanning in the first operation mode, as in the above-described embodiment. According to such a control mode, as the moving velocity of the recording head 9 in the second operation mode is set to 2/N times the moving velocity in the first operation mode in accordance with the ratio of the first and second frequencies, every other ink droplet can be ejected from the recording head 9 in the second operation mode.

The structure of the recording head 9 is not limited to the so-called flexure vibration-type driving system in which the diaphragm 35 is displaced by deformation of the piezoelectric vibrator as described in the above-described embodiments and this changes the capacity of the pressure chamber 38 to eject ink droplets. For example, the following structure may also be employed. That is, a recording head employing a so-called vertical oscillation-type driving system may be used in which a pressure chamber is expanded by deformation (contraction) of a piezoelectric vibrator due to charging while the pressure chamber is contracted by deformation (expansion) of the piezoelectric vibrator due to discharging, thereby changing the capacity of the pressure chamber to eject ink droplets.

The structure of the recording head 9 is not limited to the structure in which the silicon wafers are prepared by etching as described in the above-described embodiments. For example, it is possible to employ a recording head in which an ink flow path is formed by stacking and adhering metal plates with the pressure chamber 38, the ink supply path 39, the ink reservoir 40 and the like formed therein.

In the above-described embodiments, the first operation mode and the second operation mode are switched with reference to 40° C. (predetermined temperature). However, the reference temperature is not limited to this.

The printer 1 in each of the above-described embodiments may also has a deviation adjusting unit for adjusting (performing so-called bi-directional adjustment of) deviation in printing position (deviation in ink droplet landing position) when performing bi-directional printing by ejecting ink droplets as the recording head 9 moves forward and backward. This deviation adjusting unit is formed, for example, by the ROM 54 and the controller 55. Specifically, the controller 55 sets an adjustment value (bi-directional adjustment value) for performing bi-directional adjustment in each operation mode and stores this value to the ROM 54. As the technique for setting the bi-directional adjustment value, a value set by the user may be set or the printer 1 may automatically set a value. The controller 55 performs bi-directional adjustment in each operation mode on the basis of such a bi-directional adjustment value and thus adjusts deviation in the printing position in the bi-directional printing. In the printer 1 having such a deviation adjusting unit, lowering of the print quality due to switching of the operation modes for which different driving frequencies and moving velocities are set can be restrained.

In the printer 1 having such a deviation adjusting unit, bi-directional adjustment can be performed more accurately by setting the bi-directional adjustment value, for example, in accordance with the gap value (platen gap) between the recording head 9 and the platen 13.

In the above-described embodiments, as the liquid ejection apparatus, the box-shaped printer 1 is applied on the assumption that it is housed in a rack or the like for use. However, the printer 1 is not limited to such a mode and may have other shapes.

In the above-described embodiments, the ink jet printer is described as an example of the liquid ejection apparatus. However, this invention may also be applied to, for example, a facsimile machine, a copy machine and the like. Moreover, in terms of a liquid ejection apparatus that ejects and lands a liquid, instead of ink, corresponding to other applications than a recording apparatus, to a target medium from a liquid ejection head, this invention may be applied to, for example, an apparatus having a color material ejection head used for manufacturing a color filter of a liquid crystal display or the like, an electrode material (conductive paste) ejection head used for forming an electrode of an organic EL display, a field emission display (FED) or the like, a bio-organic material ejection head used for manufacturing a biochip, a sample ejection head as a precision pipette, or the like.

1. A liquid ejection apparatus, comprising:
a liquid ejection head, which ejects liquid droplets toward a target medium while being moved in a first direction;
a temperature detector, which detects temperature in a peripheral region of the liquid ejection head;
a signal generator, which generates a first signal including first pulses operable to drive the liquid ejection head so as to eject the liquid droplets toward a unit region in the target medium at a first frequency, and a second signal including second pulses operable to drive the liquid ejection head so as to eject the liquid droplets toward the unit region at a second frequency which is lower than the first frequency;
a mode switcher, which establishes a first mode in which the first pulses are applied to the liquid ejection head when the temperature detector detects that the temperature is no higher than a prescribed temperature, and establishes a second mode in which the second pulses are applied to the liquid ejection head when the temperature detector detects that the temperature is higher than the prescribed temperature; and
a scan controller, which moves the liquid ejection head at a first velocity when the first mode is established, and moves the liquid ejection head at a second velocity which is lower than the first velocity when the second mode is established.

2. The liquid ejection apparatus as set forth in claim 1, wherein each of the first pulses has an identical waveform with each of the second pulses.

3. The liquid ejection apparatus as set forth in claim 1, wherein a ratio of the first frequency to the second frequency is identical with a ratio of the first velocity to the second velocity.

4. The liquid ejection apparatus as set forth in claim 1, wherein the mode switcher establishes either the first mode or the second mode at the beginning of a unit ejection job, and the established mode is held during the unit ejection job.

5. The liquid ejection apparatus as set forth in claim 1, further comprising a pulse corrector, which corrects a waveform of each of the first pulses and the second pulses in accordance with the temperature detected by the temperature detector.

6. The liquid ejection apparatus as set forth in claim 1, wherein:
the liquid ejection head also ejects the liquid droplets while being moved in a second direction opposite to the first direction;
an ejection timing of each of the liquid droplets is adjusted in accordance with the direction that the liquid ejection head moves and the mode established by the mode switcher.

7. The liquid ejection apparatus as set forth in claim 6, wherein the ejection timing is adjusted also in accordance with a distance between the liquid ejection head and the target medium.

8. A method of driving a liquid ejection apparatus which comprises a liquid ejection head operable to eject liquid droplets toward a target medium while being moved in a first direction, the method comprising steps of:
detecting temperature in a peripheral region of the liquid ejection head;
generating at least one of a first signal including first pulses operable to drive the liquid ejection head so as to eject the liquid droplets toward a unit region in the target medium at a first frequency, and a second signal including second pulses operable to drive the liquid ejection head so as to eject the liquid droplets toward the unit region at a second frequency which is lower than the first frequency;
establishing a first mode in which the first pulses are applied to the liquid ejection head when the detected temperature is no higher than a prescribed temperature;
establishing a second mode in which the second pulses are applied to the liquid ejection head when the detected temperature is higher than the prescribed temperature;
moving the liquid ejection head at a first velocity when the first mode is established; and
moving the liquid ejection head at a second velocity which is lower than the first velocity when the second mode is established.

9. The driving method as set forth in claim 8, wherein either the first mode or the second mode at the beginning of a unit ejection job, and the established mode is held during the unit ejection job.

10. The driving method as set forth in claim 8, further comprising a step of correcting a waveform of each of the first pulses and the second pulses in accordance with the detected temperature.

11. A liquid ejection apparatus, comprising:
a liquid ejection head, which ejects liquid droplets toward a target medium while being moved in a first direction, the target medium having a plurality of unit regions arrayed in the first direction to form a target row;
a temperature detector, which detects temperature in a peripheral region of the liquid ejection head;
a signal generator, which generates a first signal including first pulses operable to drive the liquid ejection head so as to eject the liquid droplets toward every one of the unit regions, and a second signal including second pulses operable to drive the liquid ejection head so as to eject the liquid droplets toward every N-th one of the unit regions;
a mode switcher, which establishes a first mode in which the first pulses are applied to the liquid ejection head when the temperature detector detects that the temperature is no higher than a prescribed temperature, and establishes a second mode in which the second pulses are applied to the liquid ejection head when the temperature detector detects that the temperature is higher than the prescribed temperature; and
a scan controller, which moves the liquid ejection head once to complete the liquid droplet ejection with respect to the target row when the first mode is established, and moves the liquid ejection head N-times to complete the liquid droplet ejection with respect to the target row when the second mode is established.

12. The liquid ejection apparatus as set forth in claim 11, wherein the N is 2.

13. The liquid ejection apparatus as set forth in claim 11, wherein:
a frequency of the first signal is identical with a frequency of the second signal; and
a velocity of the liquid ejection head in the first mode is identical with a velocity of the liquid ejection head in the second mode.

14. The liquid ejection apparatus as set forth in claim 11, wherein the mode switcher establishes either the first mode or the second mode at the beginning of a unit ejection job, and the established mode is held during the unit ejection job.

15. The liquid ejection apparatus as set forth in claim 11, further comprising a pulse corrector, which corrects a waveform of each of the first pulses and the second pulses in accordance with the temperature detected by the temperature detector.

16. A method of driving a liquid ejection apparatus which comprises a liquid ejection head operable to eject liquid droplets toward a target medium having a plurality of unit regions arrayed in a first direction to form a target row, while being moved in the first direction, the method comprising steps of:
detecting temperature in a peripheral region of the liquid ejection head;
generating at least one of a first signal including first pulses operable to drive the liquid ejection head so as to eject the liquid droplets toward every one of the unit regions, and a second signal including second pulses operable to drive the liquid ejection head so as to eject the liquid droplets toward every N-th one of the unit regions;
establishing a first mode in which the first pulses are applied to the liquid ejection head when the detected temperature is no higher than a prescribed temperature;
establishing a second mode in which the second pulses are applied to the liquid ejection head when the detected temperature is higher than the prescribed temperature;
moving the liquid ejection head once to complete the liquid droplet ejection with respect to the target row when the first mode is established; and
moving the liquid ejection head N-times to complete the liquid droplet ejection with respect to the target row when the second mode is established.

17. The driving method as set forth in claim 16, wherein:
a frequency of the first signal is identical with a frequency of the second signal; and
a velocity of the liquid ejection head in the first mode is identical with a velocity of the liquid ejection head in the second mode.

18. The driving method as set forth in claim 16, wherein either the first mode or the second mode at the beginning of a unit ejection job, and the established mode is held during the unit ejection job.

19. The driving method as set forth in claim 16, further comprising a step of correcting a waveform of each of the first pulses and the second pulses in accordance with the detected temperature.

20. A liquid ejection apparatus, comprising:
a liquid ejection head, which ejects liquid droplets toward a target medium while being moved in a first direction, the target medium having a plurality of unit regions arrayed in the first direction to form a target row;
a temperature detector, which detects temperature in a peripheral region of the liquid ejection head;
a signal generator, which generates a first signal including first pulses operable to drive the liquid ejection head so as to eject the liquid droplets toward every one of the unit regions at a first frequency, and a second signal including second pulses operable to drive the liquid ejection head so as to eject the liquid droplets toward every one of the unit regions at a second frequency which is one N-th of the first frequency;
a mode switcher, which establishes a first mode in which the first pulses are applied to the liquid ejection head when the temperature detector detects that the temperature is no higher than a prescribed temperature, and establishes a second mode in which the second pulses are applied to the liquid ejection head when the temperature detector detects that the temperature is higher than the prescribed temperature; and
a scan controller, which moves the liquid ejection head once to complete the liquid droplet ejection with respect to the target row when the first mode is established, and moves the liquid ejection head N-times to complete the liquid droplet ejection with respect to the target row when the second mode is established.

21. The liquid ejection apparatus as set forth in claim 20, wherein the N is 2.

22. The liquid ejection apparatus as set forth in claim 20, wherein a velocity of the liquid ejection head in the first mode is identical with a velocity of the liquid ejection head in the second mode.

23. The liquid ejection apparatus as set forth in claim 20, wherein the mode switcher establishes either the first mode or the second mode at the beginning of a unit ejection job, and the established mode is held during the unit ejection job.

24. The liquid ejection apparatus as set forth in claim 20, further comprising a pulse corrector, which corrects a waveform of each of the first pulses and the second pulses in accordance with the temperature detected by the temperature detector.

25. A method of driving a liquid ejection apparatus which comprises a liquid ejection head operable to eject liquid droplets toward a target medium having a plurality of unit regions arrayed in a first direction to form a target row, while being moved in the first direction, the method comprising steps of:
detecting temperature in a peripheral region of the liquid ejection head;
generating at least one of a first signal including first pulses operable to drive the liquid ejection head so as to eject the liquid droplets toward every one of the unit regions at a first frequency, and a second signal including second pulses operable to drive the liquid ejection head so as to eject the liquid droplets toward every one of the unit regions at a second frequency which is one N-th of the first frequency;
establishing a first mode in which the first pulses are applied to the liquid ejection head when the detected temperature is no higher than a prescribed temperature;
establishing a second mode in which the second pulses are applied to the liquid ejection head when the detected temperature is higher than the prescribed temperature;
moving the liquid ejection head once to complete the liquid droplet ejection with respect to the target row when the first mode is established; and
moving the liquid ejection head N-times to complete the liquid droplet ejection with respect to the target row when the second mode is established.

26. The driving method as set forth in claim 25, wherein a velocity of the liquid ejection head in the first mode is identical with a velocity of the liquid ejection head in the second mode.

27. The driving method as set forth in claim 25, wherein either the first mode or the second mode at the beginning of a unit ejection job, and the established mode is held during the unit ejection job.

28. The driving method as set forth in claim 25, further comprising a step of correcting a waveform of each of the first pulses and the second pulses in accordance with the detected temperature.
